(19) United States
(12) Patent Application Publication
(10) Pub. No.: US 2009/0155649 A1
(43) Pub. Date: Jun. 18, 2009

(54) SYSTEM AND PROCESS FOR GENERATING ELECTRICAL POWER

(76) Inventors: Jingyu Cui, Katy, TX (US); Erik Edwin Engwall, Houston, TX (US); Mahendra Ladharam Joshi, Katy, TX (US); Scott Lee Wellington, Bellaire, TX (US)

Correspondence Address: SHELL OIL COMPANY, P O BOX 2463, HOUSTON, TX, 772522463, US

(21) Appl. No.: 12/335,375

(22) Filed: Dec. 15, 2008

Related U.S. Application Data
(60) Provisional application No. 61/014,285, filed on Dec. 17, 2007.
(60) Provisional application No. 61/014,259, filed on Dec. 17, 2007.

(51) Int. Cl. H01M 8/18

(52) U.S. Cl. 429/20

(57) ABSTRACT

The present invention relates to a solid oxide fuel cell system. The system includes a pre-reforming reactor, a reforming reactor, a hydrogen separation apparatus and a solid oxide fuel cell. The anode exhaust outlet of the solid oxide fuel cell is operatively connected to an inlet of the pre-reforming reactor so anode exhaust from the fuel cell may enter the pre-reforming reactor. The pre-reforming reactor also has an inlet for a hydrocarbon feed precursor. The reforming reactor is operatively coupled to the pre-reforming reactor so that a feed produced in the pre-reforming reactor from the feed precursor may be fed to the reforming reactor. The reforming reactor is operatively connected to the hydrogen separation apparatus so that hydrogen produced in the reforming reactor may be separated from the reformed product gases. The anode inlet of the solid oxide fuel cell is operatively connected to the hydrogen separation apparatus so hydrogen may be fed from the hydrogen separation apparatus as fuel to the solid oxide fuel cell.

This application claims the benefit of U.S. Provisional Application No. 61/014,285, filed Dec. 17, 2007, which is incorporated herein by reference.

### FIELD OF THE INVENTION

The present invention relates to an electrical power generating fuel cell system, and to a process for generating electrical power. In particular, the present invention relates to an electrical power generating solid oxide fuel cell system and a process for generating electrical power with such a system.

### BACKGROUND OF THE INVENTION

Solid oxide fuel cells are fuel cells that are composed of solid state elements that generate electrical power directly from an electrochemical reaction. Such fuel cells are useful in that they deliver high quality reliable electrical power, are clean operating, and are relatively compact power generators—making their use attractive in urban areas.

Solid oxide fuel cells are formed of an anode, a cathode, and a solid electrolyte sandwiched between the anode and cathode. An oxidizable fuel gas, or a gas that may be reformed in the fuel cell to an oxidizable fuel gas, is fed to the anode, and an oxygen containing gas, typically air, is fed to the cathode to provide the chemical reactants. The oxidizable fuel gas fed to the anode is typically syngas—a mixture of hydrogen and carbon monoxide. The fuel cell is operated at a high temperature, typically from 800° C. to 1100° C., to convert oxygen in the oxygen containing gas to ionic oxygen that may cross the electrolyte to interact with hydrogen and/or carbon monoxide from the fuel gas at the anode. Electrical power is generated by the conversion of oxygen to ionic oxygen at the cathode and the chemical reaction of the ionic oxygen with hydrogen and/or carbon monoxide at the anode. The following reactions describe the electrical power generating chemical reactions in the cell:
Cathode charge transfer: O₂+4e⁻→2O⁼
Anode charge transfer: H₂+O⁼→H₂O+2e⁻ and CO+O⁼→CO₂+2e⁻
   An electrical load or storage device may be connected between the anode and the cathode so an electrical current may flow between the anode and cathode, powering the electrical load or providing electrical power to the storage device.

Fuel gas is typically supplied to the anode of the fuel cell by a steam reforming reactor that reforms a low molecular weight hydrocarbon and steam into hydrogen and carbon oxides. Methane, for example as natural gas, is a preferred low molecular weight hydrocarbon used to produce fuel gas for the fuel cell. Alternatively, the fuel cell anode may be designed to internally effect a steam reforming reaction on a low molecular weight hydrocarbon such as methane and steam supplied to the anode of the fuel cell.

In some instances, a methane feed and/or other low molecular weight hydrocarbon feed used in the steam reforming reactor may be produced from a liquid fuel such as gasoline, diesel, or kerosene. The liquid fuel may be converted to a feed for the steam reforming reactor in a pre-reforming reactor. The liquid fuel may be converted to a feed for the steam reforming reactor by mixing the fuel with steam and reacting the fuel and steam at a temperature of 550° C. or greater, often 700° C. or greater.

Methane steam reforming provides a fuel gas containing hydrogen and carbon monoxide according to the following reaction: CH₄+H₂O⇄CO+3H₂. Heat must be supplied to effect the steam reforming reaction since the reaction to form hydrogen and carbon monoxide is quite endothermic. The reaction is typically conducted at a temperature in the range of 750° C. to 1100° C. to convert a substantial amount of methane or other hydrocarbon and steam to hydrogen and carbon monoxide.

Heat for 1) inducing the methane steam reforming reaction in a steam reforming reactor and, if desired, 2) for converting liquid fuel into feed for the steam reforming reactor has been conventionally provided by a burner that combusts an oxygen containing gas with a fuel, typically a hydrocarbon fuel such as natural gas, to provide the required heat. Flameless combustion has also been utilized to provide the heat for driving the steam reforming reaction, where the flameless combustion is also driven by providing a hydrocarbon fuel and a oxygen containing gas to a flameless combustor in relative amounts that avoid inducing flammable combustion. These methods for providing the heat necessary to drive a steam reforming reaction and/or a pre-reforming reaction are relatively inefficient energetically since a significant amount of thermal energy provided by combustion is not captured and is lost.

U.S. Patent Application No. 2005/0164051 discloses a system and a process in which reforming reactor and a pre-reforming reactor may be thermally integrated with a fuel cell. Heat produced by the fuel cell is used to provide heat to drive the endothermic reaction of the reforming reactor. The reforming reactor is thermally integrated with the fuel cell by placing the reforming reactor in the same hot box as the fuel cell and/or by placing the fuel cell and the reformer in thermal contact with each other. The fuel cell and the reformer may be placed in thermal contact with each other by placing the reformer in close proximity to the fuel cell, where the cathode exhaust conduit of the fuel cell may be in direct contact with the reformer (e.g. by wrapping the cathode exhaust conduit around the reformer, or by one or more walls of the reformer comprising a wall of the cathode exhaust conduit) so that the cathode exhaust from the fuel cell provides conductive heat transfer to the reformer. Supplemental heat is provided from a combustor to the reformer, where the thermal contact of the fuel cell and the reformer lowers the combustion heat requirement of the reformer to effect the reforming reaction.

Heat for the pre-reforming reactor is provided by locating the pre-reforming reactor in a hot box with catalytic start-up burner, and by providing a natural gas feed heated by heat exchange with an anode exhaust stream from the fuel cell. The pre-reforming reactor, however, is not used for converting liquid feeds into a lower molecular weight feedstock for the steam reforming reactor since natural gas is used as a feed for the pre-reforming reactor.

While more efficient than capturing thermal energy provided by combustion, the process is still relatively thermally inefficient since 1) the heat from the fuel cell is insufficient to completely drive the reforming reaction because the heat of the exhaust from the fuel cell has a temperature at or near the temperature required to drive the reforming reaction (750° C.-1100° C.), and, unless near perfect heat exchange occurs, the heat from the fuel cell will not be sufficient to drive the reforming reaction without additional heat from another source such as a combustor; and 2) significant amounts of heat from the fuel cell exhaust will be convectively transferred away from the reforming reactor as well as towards the reactor. The pre-reforming reactor also does not convert a liquid hydrocarbon feedstock to a lower molecular weight feed for the steam reforming reactor, and insufficient heat is likely provided from the fuel cell to do so.

Furthermore, solid oxide fuel cells coupled with pre-reforming and reforming reactors are typically run in a manner that is not electrochemically efficient and does not produce a high electrical power density. Solid oxide fuel cells are typically operated commercially in a “hydrogen-lean” mode, where the conditions of the production of the fuel gas, for example by steam reforming, are selected to limit the amount of hydrogen exiting the fuel cell in the fuel cell exhaust. This is done to balance the electrical energy potential of the hydrogen in the fuel gas with the potential (thermal+electrochemical) energy lost by hydrogen leaving the cell without being converted to electrical energy.

Fuel gases containing non-hydrogen compounds, such as carbon monoxide or carbon dioxide, however, are less efficient for producing electrical power in a solid oxide fuel cell than more pure hydrogen fuel gas streams. This is due to the electrochemical oxidation potential of molecular hydrogen relative to other compounds. For example, molecular hydrogen can produce an electrical power density of 1.3 W/cm² at 0.7 volts while carbon monoxide can produce an electrical power density of only 0.5 W/cm² at 0.7 volts. Therefore, fuel gas streams containing significant amounts of non-hydrogen compounds are not as efficient in producing electrical power in a solid oxide fuel cell as fuel gases containing mostly hydrogen.

Certain measures have been taken to recapture the energy of excess hydrogen exiting the fuel cell, however, these are significantly less energy efficient than if the hydrogen were electrochemically reacted in the fuel cell. For example, the anode exhaust produced by reacting the fuel gas electrochemically in the fuel cell has been combusted to drive a turbine expander to produce electricity. This, however, is significantly less efficient than capturing the electrochemical potential of the hydrogen in the fuel cell since much of the thermal energy is lost rather than converted by the expander to electrical energy. Fuel gas exiting the fuel cell also has been combusted to provide thermal energy for a variety of heat exchange applications, including driving the reforming reactor as noted above. Almost 50% of the thermal energy provided by combustion is not captured, however, and is lost. Hydrogen is a very expensive gas to use to fire a burner, therefore, conventionally, the amount of hydrogen used in the solid oxide fuel cell is adjusted to utilize most of the hydrogen provided to the fuel cell to produce electrical power and minimize the amount of hydrogen exiting the fuel cell in the fuel cell exhaust.

U.S. Patent Application Publication No. 2007/0017369 (the '369 publication) provides a method of operating a fuel cell system in which a feed is provided to a fuel inlet of the fuel cell. The feed may include a mixture of hydrogen and carbon monoxide provided from an external steam reformer or, alternatively may include a hydrocarbon feed that is reformed to hydrogen and carbon monoxide internally in the fuel cell stack. The fuel cell stack is operated to generate electricity and a fuel exhaust stream that contains hydrogen and carbon monoxide, where the hydrogen and carbon monoxide in the fuel exhaust stream are separated from the fuel exhaust stream and fed back to the fuel inlet as a portion of the feed. The fuel gas for the fuel cell, therefore, is a mixture of hydrogen and carbon monoxide derived by reforming a hydrocarbon fuel source and hydrogen and carbon monoxide separated from the fuel exhaust system. Recycling at least a portion of the hydrogen from the fuel exhaust through the fuel cell enables a high operation efficiency to be achieved. The system further provides high fuel utilization in the fuel cell by utilizing about 75% of the fuel during each pass through the stack.

U.S Patent Application Publication No. 2005/0164051 provides a method of operating a fuel cell system in which a fuel is provided to a fuel inlet of the fuel cell. The fuel may be a hydrocarbon fuel such as methane; natural gas containing methane with hydrogen and other gases; propane; biogas; an unreformed hydrocarbon fuel mixed with a hydrogen fuel from a reformer; or a mixture of a non-hydrocarbon carbon containing gas such as carbon monoxide, carbon dioxide, oxygenated carbon containing gas such as methanol, or other carbon containing gas with a hydrogen containing gas such as water vapor or syngas. The fuel cell stack is operated to generate electricity and a fuel exhaust stream that contains hydrogen. A hydrogen separator is utilized to separate non-utilized hydrogen from the fuel side exhaust stream of the fuel cell. The hydrogen separated by the hydrogen separator may be re-circulated back to the fuel cell or may be directed to a subsystem for other uses having a hydrogen demand. The amount of hydrogen re-circulated back to the fuel cell may be selected according to electrical demand or hydrogen demand, where more hydrogen is re-circulated back to the fuel cell when electrical demand is high. The fuel cell stack may be operated at a fuel utilization rate of from 0 to 100%, depending on electrical demand. When the electrical demand is high, the fuel cell is operated at a high fuel utilization rate to increase electricity production—a preferred rate is from 50 to 80%.

Systems and processes providing further improvement in the thermal efficiency and electrical efficiency in solid oxide fuel cell systems to increase their electrical power density and overall energy efficiency are desirable.

### SUMMARY OF THE INVENTION

In one aspect, the present invention is directed to a system for generating electricity, comprising:

a) a solid oxide fuel cell comprising
1) an anode having
   (i) an anode inlet; and
   (ii) an anode exhaust outlet;
2) a cathode having
   (i) a cathode inlet; and
   (ii) a cathode exhaust outlet; and
3) an electrolyte positioned between contacting and separating the anode and the cathode;

b) a pre-reforming reactor comprising
1) a pre-reforming region adapted to crack one or more hydrocarbons in a feed precursor to form a feed, said pre-reforming region containing a cracking catalyst therein positioned to contact a vaporized mixture of steam and one or more hydrocarbons of a feed precursor;
2) one or more pre-reforming reactor feed precursor inlets coupled in gas/fluid communication with the pre-reforming region through which a feed precursor may be introduced into the pre-reforming region; and
3) one or more pre-reforming reactor anode exhaust inlets coupled in gaseous communication with the pre-reforming region and operatively coupled in gaseous communication with the anode exhaust outlet, through which an anode exhaust stream from the fuel cell may be introduced into the pre-reforming region; and
4) one or more pre-reforming reactor outlets in gaseous communication with the pre-reforming region;

c) a reforming reactor comprising
1) a reforming region adapted to reform a vaporized mixture of steam and a feed comprising one or more gaseous hydrocarbons, said reforming region containing a reforming catalyst therein positioned to contact the vaporized mixture of steam and feed in the reforming region; and
2) one or more reforming region inlets coupled in gaseous communication with the reforming region and operatively coupled in gaseous communication with one or more pre-reforming reactor outlets to permit feed and steam from the pre-reforming reactor to be introduced into the reforming region of the reforming reactor; and

d) a hydrogen separation apparatus having
1) a member selectively permeable to hydrogen located in the reforming region of the reforming reactor and in gaseous communication with the reforming region of the reforming reactor;
2) a hydrogen gas outlet located in gaseous communication with the member, the member being interposed between the reforming region of the reforming reactor and the hydrogen gas outlet to permit selective flow of hydrogen from the reforming region to the hydrogen gas outlet through the member, wherein the hydrogen gas outlet is operatively coupled in gaseous communication with the anode inlet of the fuel cell to permit the flow of a hydrogen gas stream from the hydrogen separation apparatus to the anode of the fuel cell.

In another aspect, the present is directed to a system for generating electricity, comprising:

a) a solid oxide fuel cell comprising
1) an anode having
   (i) an anode inlet; and
   (ii) an anode exhaust outlet;
2) a cathode having
   (i) a cathode inlet; and
   (ii) a cathode exhaust outlet; and
3) an electrolyte positioned between contacting and separating the anode and the cathode;

b) a pre-reforming reactor comprising
1) a pre-reforming region adapted to crack one or more hydrocarbons in a feed precursor to form a feed, said pre-reforming region containing a cracking catalyst therein positioned to contact a vaporized mixture of steam and one or more hydrocarbons of a feed precursor;
2) one or more pre-reforming reactor feed precursor inlets coupled in gas/fluid communication with the pre-reforming region through which a feed precursor may be introduced into the pre-reforming region; and
3) one or more pre-reforming reactor anode exhaust inlets coupled in gaseous communication with the pre-reforming region and operatively coupled in gaseous communication with the anode exhaust outlet, through which an anode exhaust stream from the fuel cell may be introduced into the pre-reforming region; and
4) one or more pre-reforming reactor outlets in gaseous communication with the pre-reforming region;

c) a reforming reactor comprising
1) a reforming region adapted to reform a vaporized mixture of steam and a feed comprising one or more gaseous hydrocarbons, said reforming region containing a reforming catalyst therein positioned to contact the vaporized mixture of steam and feed in the reforming region; and
2) one or more reforming region inlets coupled in gaseous communication with the reforming region and operatively coupled in gaseous communication with one or more pre-reforming reactor outlets to permit feed and steam from the pre-reforming reactor to be introduced into the reforming region of the reforming reactor; and

d) a hydrogen separation apparatus having
1) a member selectively permeable to hydrogen operatively connected in gaseous communication with the reforming region of the reforming reactor;
2) a hydrogen gas outlet located in gaseous communication with the member, the member being interposed between the reforming region of the reforming reactor and the hydrogen gas outlet to permit selective flow of hydrogen from the reforming region to the hydrogen gas outlet through the member, wherein the hydrogen gas outlet is operatively coupled in gaseous communication with the anode inlet of the fuel cell to permit the flow of a hydrogen gas stream from the hydrogen separation apparatus to the anode of the fuel cell.

### BRIEF DESCRIPTION OF THE DRAWINGS

FIG. 1 is a schematic of a system of the present invention for conducting a process of the present invention including a pre-reforming reactor, a reforming reactor with a hydrogen separation apparatus located therein, and a solid oxide fuel cell.

FIG. 2 is a schematic of a system of the present invention for conducting a process of the present invention including a pre-reforming reactor, a reforming reactor, a hydrogen separation device operatively connected to the reforming reactor, and a solid oxide fuel cell.

FIG. 3 is a schematic of a basic system of the present invention including a pre-reforming reactor, a reforming reactor with a hydrogen separation apparatus located therein, and a solid oxide fuel cell.

FIG. 4 is a schematic of a basic system of the present invention including a pre-reforming reactor, a reforming reactor, a hydrogen separation apparatus operatively connected to the reforming reactor, and a solid oxide fuel cell.

### DETAILED DESCRIPTION OF THE INVENTION

The present invention provides a highly efficient process for generating electricity from a liquid hydrocarbon fuel at a high electrical power density in a system utilizing a solid oxide fuel cell. First, the process of the present invention is more thermally energetically efficient than processes disclosed in the art. Thermal energy from a fuel cell exhaust is transferred directly into a pre-reforming reactor, and a portion of this thermal energy is then transferred from the pre-reforming reactor into a reforming reactor. Optionally, thermal energy may also be transferred directly from the fuel cell into the reforming reactor. The transfer of thermal energy directly from the anode exhaust of the fuel cell to the pre-reforming reactor is highly efficient since the transfer is effected by molecularly mixing a hot anode exhaust stream from the fuel cell directly with a feed precursor and steam in the pre-reforming reactor, producing a feed that is then fed to the reforming reactor. The transfer of thermal energy from the pre-reforming reactor to the reforming reactor is also highly efficient, since the thermal energy is contained in the feed fed from the pre-reforming reactor to the reforming reactor. The optional transfer of thermal energy from the fuel cell to the reforming reactor via the fuel cell cathode exhaust is also thermally efficient since the heat transfer may take place directly within the reforming reactor.

The process of the present invention is also more thermally efficient than processes disclosed in the art since the reforming reactor may effect the production of hydrogen at lower temperatures than typical steam reforming processes. In the process of the present invention, hydrogen may be separated from the reformed product gases as the reforming reaction occurs in the reforming reactor, driving the equilibrium toward the production of hydrogen and lowering the temperature required to effect the production of hydrogen. Further, more hydrogen may be produced at the lower reforming reactor temperatures since the equilibrium of the water-gas shift reaction H₂O+CO⇄CO₂+H₂ favors the production of hydrogen at the lower reforming reactor temperatures, whereas it is not favored at conventional reforming reaction temperatures. The reforming reactor is designed to produce hydrogen at much lower temperatures than typical reforming reactors so the heat from the feed supplied from the pre-reforming reactor, or from the feed in combination with heat from the fuel cell cathode exhaust, is sufficient to drive the lower temperature reforming reaction with no extraneous heat source.

The process of the present invention also may produce a higher electrical power density in a solid oxide fuel cell system than processes disclosed in the art by utilizing a hydrogen-rich fuel. This is achieved by recycling the anode exhaust stream, which contains hydrogen and steam, through the pre-reforming reactor and the reforming reactor. Hydrogen not utilized to produce electricity in the fuel cell is recycled continuously into the pre-reforming reactor, and, ultimately, back to the fuel cell. This enables production of a high electrical power density relative to the lowest heating value of the fuel by eliminating the problem associated with losing potential energy by hydrogen leaving the cell without being converted to electrical energy.

In an embodiment of the process of the present invention, the anode of a solid oxide fuel cell is flooded with hydrogen over the entire path length of the anode so that the concentration of hydrogen at the anode electrode available for electrochemical reaction is maintained at a high level over the entire anode path length, thereby maximizing the electrical power density of the fuel cell. Use of a hydrogen-rich fuel that is primarily, and preferably almost all, hydrogen in the process maximizes the electrical power density of the fuel cell system since hydrogen has a significantly greater electrochemical potential than other oxidizable compounds typically used in solid oxide fuel cell systems such as carbon monoxide.

In an embodiment, the process of the present invention also maximizes the electrical power density of the fuel cell system by minimizing, rather than maximizing, the per pass fuel utilization rate of the fuel in the solid oxide fuel cell. The per pass fuel utilization rate is minimized to reduce the concentration of oxidation products, particularly water, throughout the anode path length of the fuel cell so that a high hydrogen concentration is maintained throughout the anode path length. A high electrical power density is provided by the fuel cell since an excess of hydrogen is present for electrochemical reaction at the anode electrode along the entire anode path length of the fuel cell. In a process directed to achieving a high per pass fuel utilization rate, for example greater than 50% fuel utilization, at a minimum the concentration of the oxidation products is equivalent to the concentration of hydrogen in the fuel exhaust, and the concentration of oxidation products in the fuel cell decreases the electrical power the fuel cell provides. A high electrical power density is provided by the fuel cell since an excess of hydrogen is present for electrochemical reaction at the anode electrode along the entire anode path length of the fuel cell. In a process directed to achieving a high per pass fuel utilization rate, for example greater than 60% fuel utilization, the concentration of oxidation products may comprise greater than 30% of the fuel stream before the fuel has traveled even halfway through the fuel cell, and may be several multiples of the concentration of hydrogen in the fuel cell exhaust so that the electrical power provided along the anode path may significantly decrease as the fuel provided to the fuel cell progresses through the anode.

In another aspect, the present invention is directed to a system for generating electricity at a high electrical power density in a highly efficient manner.

As used herein, the term “hydrogen” refers to molecular hydrogen unless specified otherwise.

As used herein, the “amount of water formed in the fuel cell per unit time of measurement” is calculated as follows: Amount of Water Formed in Fuel Cell per Unit Time of Measurement=[Amount of Water Measured Exiting the Fuel Cell in the Anode Exhaust of the Fuel Cell Per Unit of Time of Measurement]−[Amount of Water Present in the Fuel Fed to the Anode of the Fuel Cell Per Unit of Time of Measurement]. For example, if measurements of the amount of water in a fuel fed to the anode of a fuel cell and exiting the fuel cell in the anode exhaust are taken for 2 minutes, where the measured amount of water in the fuel fed to the anode is 6 moles and the measured amount of water exiting the fuel cell in the anode exhaust is 24 moles, the amount of water formed in the fuel cell as calculated herein is (24 moles/2 minutes)−(6 moles/2 minutes)=12 moles/min−3 moles/min=9 moles/min.

As used herein, when two or more elements are described as “operatively connected” or “operatively coupled”, the elements are defined to be directly or indirectly connected to allow direct or indirect fluid flow between the elements. The term “fluid flow”, as used herein, refers to the flow of a gas or a fluid. When two or more elements are described as “selectively operatively connected” or “selectively operatively coupled”, the elements are defined to be directly or indirectly connected or coupled to allow direct or indirect fluid flow of a selected gas or fluid between the elements. As used in the definition of “operatively connected” or “operatively coupled” the term “indirect fluid flow” means that the flow of a fluid or a gas between two defined elements may be directed through one or more additional elements to change one or more aspects of the fluid or gas as the fluid or gas flows between the two defined elements. Aspects of a fluid or a gas that may be changed in indirect fluid flow include physical characteristics, such as the temperature or the pressure of a gas or a fluid, and/or the composition of the gas or fluid, e.g. by separating a component of the gas or fluid, for example, by condensing water from a gas stream containing steam. “Indirect fluid flow”, as defined herein, excludes changing the composition of the gas or fluid between the two defined elements by chemical reaction, for example, oxidation or reduction of one or more elements of the fluid or gas.

As used herein, the term “selectively permeable to hydrogen” is defined as permeable to molecular hydrogen or elemental hydrogen and impermeable to other elements or compounds such that at most 10%, or at most 5%, or at most 1% of the non-hydrogen elements or compounds may permeate what is permeable to molecular or elemental hydrogen.

As used herein, the term “high temperature hydrogen-separation device” is defined as a device or apparatus effective for separating hydrogen, in molecular or elemental form, from a gas stream at a temperature of at least 250° C., typically at temperatures of from 300° C. to 650° C.

As used herein, “per pass hydrogen utilization” as referring to the utilization of hydrogen in a fuel in a solid oxide fuel cell, is defined as the amount of hydrogen in a fuel utilized to generate electricity in one pass through the solid oxide fuel cell relative to the total amount of hydrogen in a fuel input into the fuel cell for that pass. The per pass hydrogen utilization may be calculated by measuring the amount of hydrogen in a fuel fed to the anode of a fuel cell, measuring the amount of hydrogen in the anode exhaust of the fuel cell, subtracting the measured amount of hydrogen in the anode exhaust of the fuel cell from the measured amount of hydrogen in the fuel fed to the fuel cell to determine the amount of hydrogen used in the fuel cell, and dividing the calculated amount of hydrogen used in the fuel cell by the measured amount of hydrogen in the fuel fed to the fuel cell. The per pass hydrogen utilization may be expressed as a percent by multiplying the calculated per pass hydrogen utilization by 100.

As used herein, the term “reforming reactor” refers to a reactor in which a hydrocarbon reforming reaction and, optionally, other reactions such as a water-gas shift reaction, may take place. Reactions that occur in a reforming reactor, as used herein, may be predominantly hydrocarbon reforming reactions, but need not be predominantly hydrocarbon reforming reactions. For example, a majority of reactions occurring in a “reforming reactor” may actually be shift reactions in certain instances rather than hydrocarbon reforming reactions.

As used herein, the term “pre-reforming reactor” refers to a reactor in which a cracking reaction, and optionally, other reactions such as a reforming reaction, and optionally, physical transformations of a material such as vaporization may take place. Cracking reactions that may take place in the pre-reforming reactor break hydrocarbon molecules into simpler molecules. Cracking may involve the reduction of the molecular chain length of hydrocarbon compounds and/or the reduction of the molecular weight of hydrocarbon compounds in the pre-reforming reactor. For example, cracking reactions that may take place in the pre-reforming reactor may reduce the molecular chain length of hydrocarbon compounds having at least four carbon atoms to hydrocarbon compounds having at most 3 carbon atoms. The cracking reactions that may take place in the pre-reforming reactor may be thermal cracking reactions or hydrocracking reactions.

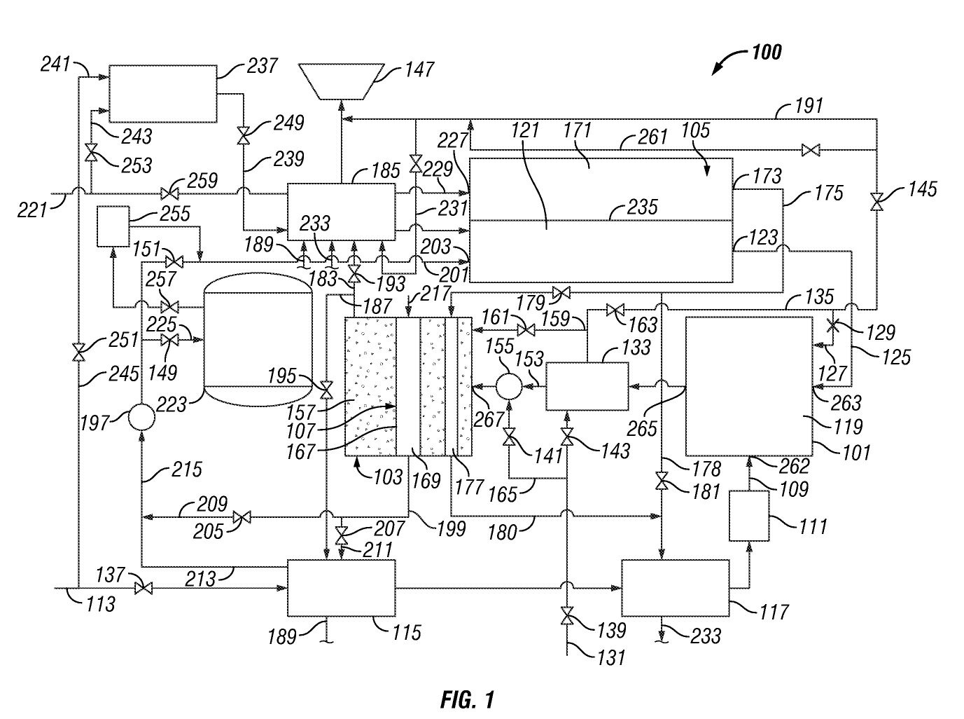

Referring now to FIG. 1, the process of the present invention utilizes a thermally integrated system 100 including a pre-reforming reactor, a hydrogen-separating reforming reactor, and a solid oxide fuel cell to generate electrical power. The process uses a liquid hydrocarbon feed precursor that may be cracked, and in an embodiment partially reformed, to a gaseous hydrocarbon feed in a first reactor 101, referred to herein as a pre-reforming reactor, which may then be reformed in a second reactor 103, referred to herein as a reforming reactor, to produce a reformed product gas from which hydrogen may be separated by a hydrogen separating device 107 in the reforming reactor 103. The hydrogen may be utilized to generate electricity in a solid oxide fuel cell 105. The process is thermally integrated, where heat to drive the endothermic cracking reactions in the pre-reforming reactor 101 and endothermic reforming reactions in the reforming reactor 103 is provided from the exothermic solid oxide fuel cell 105.

In the process, a feed precursor that contains a liquid hydrocarbon from which hydrogen may be derived may be fed to the pre-reforming reactor 101 via line 109. The feed precursor may contain one or more of any vaporizable hydrocarbon that is liquid at 20° C. at atmospheric pressure (optionally oxygenated) that is vaporizable at temperatures up to 400° C. at atmospheric pressure. Such feed precursors may include, but are not limited to, light petroleum fractions such as naphtha, diesel, and kerosene, having a boiling point range of 50-205° C. Such feed precursors may also include oxygenated hydrocarbons, including, but not limited to, methanol, ethanol, propanol, isopropanol, and butanol. The feed precursor may optionally contain some hydrocarbons that are gaseous at 20° C. such as methane, ethane, propane, or other compounds containing from one to four carbon atoms that are gaseous at 20° C. (atmospheric pressure). In an embodiment, the feed precursor may contain at least 0.5, or at least 0.6, or at least 0.7, or at least 0.8 mole fraction of hydrocarbons containing at least five, or at least six, or at least seven carbon atoms. In an embodiment the feed precursor may be decane. In a preferred embodiment, the feed precursor may be diesel fuel.

In an embodiment, the feed precursor may be fed to the pre-reforming reactor 101 at a temperature of at least 150° C., preferably from 200° C. to 500° C., where the feed precursor may be heated to a desired temperature in heat exchangers as described below. The temperature that the feed precursor is fed to the pre-reforming reactor may be selected to be as high as possible without cracking the feed precursor and producing coke, and typically may be selected to be a temperature of from 400° C. to 500° C. Alternatively, but less preferred, the feed precursor may be fed directly to the pre-reforming reactor 101 at a temperature of less than 150° C., for example without heating the feed precursor, provided the sulfur content of the feed precursor is low.

The feed precursor may be desulfurized in a desulfurizer 111 prior to being fed to the pre-reforming reactor 101 to remove sulfur from the feed precursor so the feed precursor does not poison any catalyst in the pre-reforming reactor 101. In an embodiment, the feed precursor is heated prior to being desulfurized in the desulfurizer 111. The feed precursor may be fed into the system 100 through a feed precursor inlet line 113, and optionally into heat exchanger 115 to be heated by exchange of heat with a hydrogen gas stream exiting the reforming reactor 103 and/or by a hydrogen depleted reformed product gas stream exiting the reforming reactor 103 as described in further detail below. The feed precursor may be optionally heated further in heat exchanger 117 by exchanging heat with a cathode exhaust stream from the fuel cell 105 prior to being fed to the pre-reforming reactor 101. The feed precursor may be desulfurized in desulfurizer 111 after being heated in heat exchanger 117 (as shown) or prior to being heated in the heat exchanger 117 (not shown), but before being fed to the pre-reforming reactor 101. The feed precursor may be desulfurized in the desulfurizer 111 by contact with a conventional hydrodesulfurizing catalyst under conventional desulfurizing conditions.

The feed precursor is fed into the pre-reforming region 119 of the pre-reforming reactor 101. The pre-reforming region 119 may, and preferably does, contain a pre-reforming catalyst therein. The pre-reforming catalyst may be a conventional pre-reforming catalyst, and may be any known in the art. Typical pre-reforming catalysts which can be used include, but are not limited to, Group VIII transition metals, particularly nickel and a support or substrate that is inert under high temperature reaction conditions. Suitable inert compounds for use as a support for the high temperature pre-reforming/hydrocracking catalyst include, but are not limited to, α-alumina and zirconia.

An anode exhaust stream separated from the anode 121 of the solid oxide fuel cell 105 is also fed into the pre-reforming region 119 of the pre-reforming reactor 101. The anode exhaust may be fed directly from the anode exhaust outlet 123 to the pre-reforming reactor 101 through line 125.

The anode exhaust stream is comprised of reaction products from the oxidation of fuel fed to the anode 121 of the fuel cell 105 and unreacted fuel, and is comprised of hydrogen and steam. In an embodiment, the anode exhaust stream contains at least 0.5, or at least 0.6, or at least 0.7 mole fraction hydrogen. The hydrogen in the anode exhaust stream fed to the pre-reforming reactor 101 may help prevent the formation of coke in the pre-reforming reactor 101. In an embodiment, the anode exhaust stream contains at most 0.4, or at most 0.3, or at most 0.2 mole fraction water (as steam). The steam in the anode exhaust stream fed to the pre-reforming reactor 101 also may help prevent the formation of coke in the pre-reforming reactor 101.

Optionally, steam may be fed to the pre-reforming reactor 101 via line 127 to be mixed with the feed precursor in a pre-reforming region 119 of the pre-reforming reactor 101. Steam may be fed to the pre-reforming reactor 101 to inhibit or prevent coke formation in the pre-reforming reactor 101 and, optionally, to be utilized in reforming reactions effected in the pre-reforming reactor 101. In an embodiment, steam may be fed to the pre-reforming region 119 of the pre-reforming reactor 101 at a rate wherein the molar ratio of steam added to the pre-reformer 101 through line 127 is at least twice, at least three times, or at least four times the moles of carbon in the feed precursor added to the pre-reformer. Providing a molar ratio of at least 2:1, or at least 3:1, or at least 4:1 steam to carbon in the feed precursor in the pre-reforming reactor 101 may be useful to inhibit coke formation in the pre-reforming region 119 of the pre-reforming reactor 101. Metering valve 129 may be used to control the rate that steam is fed to the pre-reforming reactor 101 through line 127.

Steam that is fed to the pre-reforming reactor may be fed to the pre-reforming reactor at a temperature of at least 125° C., preferably from 150° C. to 300° C., and may have a pressure of from 0.1 MPa to 0.5 MPa, preferably having a pressure equivalent to or below the pressure of the anode exhaust stream fed to the pre-reforming reactor 101 as described below. The steam may be generated by feeding high pressure water, having a pressure of at least 1.0 MPa, preferably 1.5 MPa to 2.0 MPa, into the system 100 through water inlet line 131 to one or more heat exchangers 133. The high pressure water is heated to form high pressure steam by exchanging heat with feed exiting the pre-reforming reactor in the one or more heat exchangers 133. Upon exiting the heat exchanger 133, or the final heat exchanger 133 if more than one heat exchanger 133 is utilized, the high pressure steam may then be fed to line 127 via line 135. The high pressure steam may be depressurized to the desired pressure by expanding the high pressure steam through an expander, then feeding to it to the pre-reforming reactor. Alternatively, steam may be generated for use in the pre-reforming reactor by feeding low pressure water through the one or more heat exchangers 133 and passing the resulting steam into the pre-reforming reactor 101.

The feed precursor, optional steam, and the anode exhaust stream are mixed and contacted with the pre-reforming catalyst in the pre-reforming region 119 of the pre-reforming reactor 103 at a temperature effective to vaporize any feed precursor not in vapor form and to crack the feed precursor to form the feed. In an embodiment, the feed precursor, optional steam, and anode exhaust stream are mixed and contacted with the pre-reforming catalyst at a temperature of at least 600° C., or from 750° C. to 1050° C., or from 800° C. to 900° C.

The anode exhaust stream fed from the exothermic solid oxide fuel cell 105 to the pre-reforming reactor 101 supplies heat to drive the endothermic cracking reactions in the pre-reforming reactor 101. The anode exhaust stream fed from the solid oxide fuel cell 105 to the pre-reforming reactor 101 is very hot, having a temperature of at least 800° C., typically having a temperature of from 850° C. to 1100° C., or from 900° C. to 1050° C. The transfer of thermal energy from the solid oxide fuel cell 105 to the pre-reforming reactor 101 is extremely efficient since thermal energy from the solid oxide fuel cell 105 is contained in the anode exhaust stream, and is transferred to the mixture of feed precursor, optional steam, and anode exhaust stream in the pre-reforming region 119 of the pre-reforming reactor 101 by directly mixing the anode exhaust stream with the feed precursor and steam.

In a preferred embodiment of the process of the present invention the anode exhaust stream provides at least 99%, or substantially all, of the heat required to produce the feed from the mixture of feed precursor, optional steam, and anode exhaust stream. In a particularly preferred embodiment, no heat source other than the anode exhaust stream is provided to the pre-reforming reactor to convert the feed precursor to the feed.

The relative rates at which the feed precursor, optional steam, and anode exhaust stream are fed to the pre-reforming reactor 101 may be selected and controlled such that the heat provided by the anode exhaust stream is sufficient to provide at least 99%, or substantially all, of the heat required to produce the feed in the pre-reforming reactor 101. The rate at which the feed precursor is fed to the pre-reforming reactor 101 may be controlled by adjusting metering valve 137, which controls the rate that the feed precursor is fed to the system 100. The rate at which steam, other than steam in the anode exhaust stream, is fed to the pre-reforming reactor 101 may be controlled by adjusting metering valve 139, which controls the rate water is fed to the system 100, or by adjusting metering valves 143 and 141, which control the rates at which steam is fed to the pre-reforming reactor 101 and the reforming reactor 103, or by adjusting metering valves 129 and 145, which control the rates at which steam is fed to the pre-reforming reactor and to a turbine 147, or by adjusting metering valves 161 and 163 which control the rates at which steam is fed to the reforming reactor 103 and the pre-reforming reactor 101. The rate at which the anode exhaust stream is fed to the pre-reforming reactor may be controlled by adjusting the pressure in the reforming reactor 103 to increase or decrease hydrogen flux across the hydrogen-separating device 107, or by adjusting metering valves 149 and 151.

In an embodiment, the pressure at which the anode exhaust stream, the feed precursor, and the optional steam are contacted with the pre-reforming catalyst in the pre-reforming region 119 of the pre-reforming reactor 101 may range from 0.07 MPa to 3.0 MPa. If the high pressure steam is not fed to the pre-reforming reactor, the anode exhaust stream, the feed precursor, and optional low pressure steam may be contacted with the pre-reforming catalyst in the pre-reforming region 119 of the pre-reforming reactor 101 at a pressure at the low end of this range, typically from 0.07 MPa to 0.5 MPa, or from 0.1 MPa to 0.3 MPa. If high pressure steam is fed to the pre-reforming reactor, the anode exhaust stream, the feed precursor, and the steam may be contacted with the pre-reforming catalyst in the pre-reforming region 119 of the pre-reforming reactor 101 at the higher end of this pressure range, typically from 1.0 MPa to 3.0 MPa, or from 1.5 MPa to 2.0 MPa.

Contacting the feed precursor, steam, and the anode exhaust stream in the pre-reforming reactor 101 at a temperature of at least 600° C., or from 750° C. to 1050° C., or from 800° C. to 900° C. cracks the feed precursor and forms the feed. The feed precursor is cracked by reducing the number of carbon atoms in compounds in the feed precursor and thereby producing compounds having reduced molecular weight. In an embodiment, the feed precursor may comprise hydrocarbons containing at least 5, or at least 6, or at least 7 carbon atoms that are converted to hydrocarbons useful as feed to the reforming reactor 103 containing at most 4, or at most 3, or at most 2 carbon atoms. In an embodiment, the feed precursor may comprise at least 0.5, or at least 0.6, or at least 0.7 mole fraction of hydrocarbons having containing at least 5, or at least 6, or at least 7 carbon atoms, and the hydrocarbon portion of the resulting feed may be comprised at least 0.5, or at least 0.6, or at least 0.7, or at least 0.8 mole fraction of hydrocarbons containing at most 4 carbon atoms, or at most 3, or at most 2 carbon atoms. In an embodiment, the feed precursor may be reacted in the pre-reforming reactor 101 such that the feed produced in the pre-reforming reactor 101 may be comprised of not more than 0.1, or not more than 0.05, or not more than 0.01 mole fraction of hydrocarbons with four carbon atoms or more. In an embodiment that feed precursor may be cracked such that at least 0.7, or at least 0.8, or at least 0.9, or at least 0.95 mole fraction of the hydrocarbons in the feed produced from the feed precursor is methane.

As noted above, hydrogen and steam from the anode exhaust stream and optional steam added to the pre-reforming reactor 101 inhibit the formation of coke in the pre-reforming reactor 101 as the feed precursor is cracked to form the feed. In a preferred embodiment, the relative rates that the anode exhaust stream, the feed precursor, and the steam are fed to the pre-reforming reactor 101 are selected so the hydrogen and steam in the anode exhaust stream and the steam added to the pre-reforming reactor 101 via line 127 prevent the formation of coke in the pre-reforming reactor 101.

In an embodiment, contacting the feed precursor, steam and anode exhaust with the pre-reforming catalyst in the pre-reforming reactor 101 at a temperature of at least 600° C., or from 750° C. to 1050° C., or from 800° C. to 900° C. may also effect at least some reforming of the hydrocarbons in the feed precursor and feed produced within the pre-reforming reactor 101 to produce hydrogen and carbon oxides, particularly carbon monoxide. The amount of reforming may be substantial, where the feed resulting from both cracking and reforming in the pre-reforming reactor may contain at least 0.05, or at least 0.1, or at least 0.15 mole fraction carbon monoxide.

The temperature and pressure conditions in the pre-reforming region 119 of the pre-reforming reactor 101 may be selected so the feed produced in the pre-reforming reactor 101 comprises light hydrocarbons that are gaseous at 20° C., typically containing 1 to 4 carbon atoms. In a preferred embodiment, the hydrocarbons in the feed are comprised of at least 0.6, or at least 0.7, or at least 0.8, or at least 0.9 mole fraction methane. The feed also comprises hydrogen from the anode exhaust stream and, if reforming is effected in the pre-reforming reaction, from reformed feed precursor compounds. The feed also comprises steam from the anode exhaust stream and, optionally, from the pre-reformer steam feed. If substantial reforming is effected in the pre-reforming reactor 101 the feed produced in the pre-reforming reactor 101 that is fed to the reforming reactor 103 may also comprise carbon monoxide.

In the process of the invention, the feed is fed from the pre-reforming reactor 101 to the reforming reactor 103, which is operatively connected to the pre-reforming reactor 101 through line 153. The feed may be optionally cooled in one or more heat exchangers 133 prior to being fed to the reforming reactor 103. The feed may also optionally be compressed in a compressor 155 prior to being fed to the reforming reactor 103.

The temperature of the feed exiting the pre-reforming reactor 101 may be lowered prior to being fed to the reforming reactor 103. The feed exiting the pre-reforming reactor may have a temperature of from 600° C. to 1000° C. The feed may be passed through one or more heat exchangers 133 to cool the feed. The feed may be cooled by exchanging heat with water fed into the system 100, cooling the feed and producing steam that may be fed to the pre-reforming reactor 101 as described above. If more than one heat exchanger 133 is utilized, the feed and water/steam may be fed in series to each of the heat exchangers 133 preferably in a countercurrent flow to cool the feed and to heat the water/steam. The feed may be cooled to a temperature of from 150° C. to 650° C., or from 150° C. to 300° C., or from 400° C. to 650° C., or from 450° C. to 550° C. The cooled feed may be fed from the one or more heat exchangers 133 to the compressor 155, or, in another embodiment, may be fed directly to the reforming reactor 103. Alternatively, but less preferably, the feed exiting the pre-reforming reactor 101 may be fed to the compressor 155 or the reforming reactor 103 without cooling.

In addition to being cooled by the one or more heat exchangers 133, if necessary to raise the pressure in the reforming region 157 of the reforming reactor 103 to a pressure of at least 0.5 MPa, the feed may be compressed by compressor 155 to a pressure of at least 0.5 MPa, or at least 1.0 MPa, or at least 1.5 MPa, or at least 2 MPa, or at least 2.5 MPa, or at least 3 MPa to maintain sufficient pressure in the reforming region 157 of the reforming reactor 103 to drive the hydrogen present in the feed and produced from the feed in the reforming reactor 103 through the hydrogen-separation device 107 in the reforming reactor 103. The compressor 155 is a compressor capable of operating at high temperatures, and preferably is a commercially available StarRotor compressor.

The optionally compressed, optionally cooled feed comprising hydrogen, light hydrocarbons, steam, and optionally, carbon monoxide, is fed to the reforming reactor 103. The feed may have a pressure of at least 0.5 MPa and a temperature of from 400° C. to 800° C., preferably from 400° C. to 650° C.

Optionally, additional steam may be added into the reforming region 157 of the reforming reactor 103 for mixing with the feed if necessary for reforming the feed. In a preferred embodiment, the additional steam may be added by injecting high pressure water from the water inlet line 131 into the compressor 155 through line 165 for mixing with the feed as the feed is compressed in the compressor 155. In an embodiment (not shown), high pressure water may be injected into the feed by mixing the high pressure water and feed in one or more of the heat exchangers 133. In another embodiment (not shown), high pressure water may be injected into the feed in line 153 either before or after passing the feed to the one or more heat exchangers 133 or before or after passing the feed to the compressor 155. In an embodiment, high pressure water may be injected into line 153, or into compressor 155, or in the one or more heat exchangers 133, where either the compressor 155 or the one or more heat exchangers 133 is not included in the system 100.

The high pressure water is heated to form steam by mixing with the feed, and the feed is cooled by mixing with the water. The cooling provided to the feed by the water injected therein may eliminate or reduce the need for the one or more heat exchangers 133, preferably limiting the number of heat exchangers 133 used to cool the feed to at most one.

Alternatively, but less preferred, high pressure steam may be injected into the reforming region 157 of the reforming reactor 103 or the line 153 to the reforming reactor 103 to be mixed with the feed. The high pressure steam may be steam produced by heating high pressure water injected into the system 100 through water inlet line 131 in the one or more heat exchangers 133 by exchanging heat with the feed exiting the pre-reforming reactor 101. The high pressure steam may be fed to the reforming reactor 101 through line 159. Metering valves 161 and 163 may be used to control the flow of steam to the reforming reactor 103. The high pressure steam may have a pressure similar to that of the feed being fed to the reforming reactor 103. Alternatively, the high pressure steam may be fed to line 153 to be mixed with the feed prior to the feed being fed to compressor 155 so the mixture of steam and feed may be compressed together to a selected pressure. The high pressure steam may have a temperature of from 200° C. to 500° C.

The rate the high pressure water or high pressure steam is injected into the feed may be selected to provide an amount of steam to the reforming reactor 103 effective to optimize reforming and water gas shift reactions to produce hydrogen in the reforming reactor 103. If high pressure water is injected into the feed, metering valves 139, 141, and 143 may be adjusted to control the rate the water is injected into the feed through line 165. If high pressure steam is injected into the reforming reactor 103 or into line 153, metering valves 139, 143, 161, and 163 may be adjusted to control the rate the steam is injected into the reforming reactor 103 or into line 153.

The feed and, optionally, additional steam are fed into the reforming region 157 of the reforming reactor 103. The reforming region may, and preferably does, contain a reforming catalyst therein. The reforming catalyst may be a conventional steam reforming catalyst, and may be known in the art. Typical steam reforming catalysts which can be used include, but are not limited to, Group VIII transition metals, particularly nickel. It is often desirable to support the reforming catalysts on a refractory substrate (or support). The support, if used, is preferably an inert compound. Suitable inert compounds for use as a support contain elements of Group III and IV of the Periodic Table, such as, for example the oxides or carbides of Al, Si, Ti, Mg, Ce, and Zr.

The feed and, optionally additional steam, are mixed and contacted with the reforming catalyst in the reforming region 157 at a temperature effective to form a reformed product gas containing hydrogen and carbon oxides. The reformed product gas may be formed by steam reforming the hydrocarbons in the feed. The reformed product gas may also be formed by water-gas shift reacting steam and carbon monoxide in the feed and/or produced by steam reforming the feed. In an embodiment, the reforming reactor 103 may act more as a water-gas shift reactor if a substantial amount of reforming was effected in the pre-reforming reactor and the feed contains substantial amounts of carbon monoxide. The reformed product gas may contain hydrogen and at least one carbon oxide. Carbon oxides that may be in the reformed product gas include carbon monoxide and carbon dioxide.

One or more high temperature tubular hydrogen-separation membranes 107 may be located in the reforming region 157 of the reforming reactor 103 positioned so that the feed and the reformed product gas may contact the hydrogen separation membrane(s) 107 and hydrogen may pass through membrane wall 167 of the membrane(s) 107 to a hydrogen conduit 169 located within the tubular membrane(s) 107. The membrane wall 167 of each respective hydrogen separation membrane 107 separates the hydrogen conduit 169 of the membrane 107 from gaseous communication with non-hydrogen compounds of the reformed product gas, feed, and steam in the reforming region 157 of the reforming reactor 103. The membrane wall 167 is selectively permeable to hydrogen, elemental and/or molecular, so that hydrogen in the reforming region 157 may pass through the membrane wall 167 of a membrane 107 to the hydrogen conduit 169 while other gases in the reforming region 157 are prevented from passing to the hydrogen conduit 169 by the membrane wall 167.

The high temperature tubular hydrogen-separation membrane(s) 107 in the reforming region may comprise a support coated with a thin layer of a metal or alloy that is selectively permeable to hydrogen. The support may be formed of a ceramic or metallic material that is porous to hydrogen. Porous stainless steel or porous alumina are preferred materials for the support of the membrane 107. The hydrogen selective metal or alloy coated on the support may be selected from metals of Group VIII, including, but not limited to Pd, Pt, Ni, Ag, Ta, V, Y, Nb, Ce, In, Ho, La, Au, and Ru, particularly in the form of alloys. Palladium and platinum alloys are preferred. A particularly preferred membrane 107 used in the present process has a very thin film of a palladium alloy having a high surface area coating a porous stainless steel support. Membranes of this type can be prepared using the methods disclosed in U.S. Pat. No. 6,152,987. Thin films of platinum or platinum alloys having a high surface area would also be suitable as the hydrogen selective material.

The pressure within the reforming region 157 of the reforming reactor 103 is maintained at a level significantly above the pressure within the hydrogen conduit 169 of the tubular membrane 107 so that hydrogen is forced through the membrane wall 167 from the reforming region 157 of the reforming reactor into the hydrogen conduit 169. In an embodiment, the hydrogen conduit 169 is maintained at or near atmospheric pressure, and the reforming region 157 is maintained at a pressure of at least 0.5 MPa, or at least 1.0 MPa, or at least 2 MPa, or at least 3 MPa. As noted above, the reforming region 157 may be maintained at such elevated pressures by compressing the feed from the pre-reforming reactor 101 with compressor 155 and injecting the mixture of feed at high pressure into the reforming region 157. Alternatively, the reforming region 157 may be maintained at such high pressures by mixing high pressure steam with the feed as described above and injecting the high pressure mixture into the reforming region 157 of the reforming reactor 103. Alternatively, the reforming region 157 may be maintained at such high pressures by mixing high pressure steam with the feed precursor in the pre-reforming reactor 101 and injecting a high pressure feed produced in the pre-reforming reactor 101 into the reforming reactor 103 either directly or through one or more heat exchangers 133. The reforming region 157 of the reforming reactor 103 may be maintained at a pressure of at least 0.5 MPa, or at least 1.0 MPa, or at least 2.0 MPa, or at least 3.0 MPa.

The temperature at which the feed, and optionally additional steam, is/are mixed and contacted with the reforming catalyst in the reforming region 157 of the reforming reactor 103 is at least 400° C., and preferably may range from 400° C. to 650° C., most preferably in a range of from 450° C. to 550° C. Unlike typical steam reforming reactions, which produce hydrogen at temperatures in excess of 750° C., the equilibrium of the reforming reaction in the present process is driven towards the production of hydrogen in the reforming reactor operating temperature range of 400° C. to 650° C. since hydrogen is removed from the reforming region 157 into the hydrogen conduit 169 of the hydrogen separation membrane(s) 107 and thence removed from the reforming reactor 103. An operating temperature of 400° C. to 650° C. favors the shift reaction as well, converting carbon monoxide and steam to more hydrogen, which is then removed from the reforming region 103 into the hydrogen conduit 169 of the hydrogen separation membrane(s) 107 through the membrane wall 167 of the membrane(s) 107. Nearly complete conversion of hydrocarbons and carbon monoxide to hydrogen and carbon dioxide by the reforming and water gas shift reactions is achieved in the reforming reactor 103 since equilibrium is never reached due to the continuous removal of hydrogen from the reforming reactor 103.

The feed fed from the pre-reforming reactor 101 to the reforming reactor 103 supplies heat to drive the reactions in the reforming reactor 103. The feed fed from the pre-reforming reactor 101 to the reforming reactor 103 may contain sufficient thermal energy to drive the reactions in the reforming reactor 103, and may have a temperature of from 600° C. to 1000° C. The thermal energy of the feed from the pre-reforming reactor 101 may be in excess of the thermal energy needed to drive the reactions in the reforming reactor 103, and, as described above, the feed may be cooled to a temperature of from 400° C. to less than 600° C. in the one or more heat exchangers 133 and/or by injecting water into the feed prior to the feed being fed to the reforming reactor 103. Cooling the feed prior to feeding the feed to the reforming reactor 103 may be preferable so that 1) the temperature within the reforming reactor 103 may be adjusted to favor the production of hydrogen in the water-gas shift reaction; 2) the membrane 107 life-span may be extended; and 3) to improve compressor 155 performance. The transfer of thermal energy from the pre-reforming reactor 101 to the reforming reactor 103 is extremely efficient since thermal energy from the pre-reforming reactor 101 is contained in the feed, which is intimately involved in the reactions within the reforming reactor 103.

If desired, although typically not necessary, additional heat may be supplied to the reforming reactor 103 from a hot cathode exhaust stream from the solid oxide fuel cell 105. A hot cathode exhaust stream having a temperature of from 800° C. to 1100° C. exits the cathode 171 of the fuel cell 105 from cathode exhaust outlet 173 and may be fed through line 175 to one or more cathode exhaust conduit(s) 177 that may be located within the reforming region 157 of the reforming reactor 103. Heat from the hot cathode exhaust stream may be exchanged between the cathode exhaust stream and the feed and, optionally, the additional steam, in the reforming region 157 of the reforming reactor 103 as the cathode exhaust stream passes through the cathode exhaust conduit(s) 177.

The heat exchange, if any, from the cathode exhaust stream from the fuel cell 105 to the endothermic reforming reactor 101 is efficient. Location of the cathode exhaust conduit(s) 177 within the reforming region 157 of the reforming reactor 103 permits exchange of heat between the hot cathode exhaust stream and the feed and, if present, the additional steam, within the reactor 103, transferring heat to the feed and, if present, additional steam, at the location that the reforming and shift reactions take place. Further, location of the cathode exhaust conduit(s) 177 within the reforming region 157 permits the hot cathode exhaust stream to heat the reforming catalyst in the reforming region 157 as a result of the close proximity of the conduit(s) 177 to the catalyst bed.

Provision of heat from the cathode exhaust stream to the reforming reactor 103 may be controlled by selecting and controlling the rate the cathode exhaust stream is fed to the cathode exhaust conduit(s) 177 in the reforming reactor 103, which is controlled by operation of metering valves 179 and 181. Any portion of the cathode exhaust stream not fed to the cathode exhaust conduit(s) 177 to provide heat to the reforming reactor 103 may be directed through line 178 to heat exchanger 117 where the cathode exhaust stream may exchange heat with the feed precursor to heat the feed precursor. Metering valves 179 and 181 may be adjusted in coordination to permit the cathode exhaust stream to flow through line 175 to the cathode exhaust conduit(s) 177 in the reforming reactor 103 at a selected rate and any portion of the cathode exhaust stream not used to provide heat to the reforming reactor 103 to flow through line 178 to heat exchanger 117. Further heat may be supplied to heat exchanger 117 to heat the feed precursor by feeding a cooled cathode exhaust stream exiting the cathode exhaust conduit(s) 177 in the reforming reactor 103 to heat exchanger 117 through line 180, where the cooled cathode exhaust stream has sufficient thermal energy to provide heat to the feed precursor.

In an embodiment, the feed from the pre-reforming reactor 101 contains sufficient heat to drive the reactions in the reforming reactor 103, and the cathode exhaust stream is not fed to the reforming reactor 103 but may be fed to heat exchanger 117 to heat the feed precursor. In this embodiment, no cathode exhaust conduits 177 need be included in the reforming reactor 103.

A hydrogen-depleted reformed product gas stream may be removed from the reforming region 157 via line 183, where the hydrogen-depleted reformed product gas stream may include unreacted feed and gaseous non-hydrogen reformed products in the reformed product gas. The non-hydrogen reformed products and unreacted feed may include carbon dioxide, water (as steam), and small amounts of carbon monoxide and unreacted hydrocarbons. Small amounts of hydrogen may be contained in the hydrogen-depleted reformed product gas stream as well.

In an embodiment, the hydrogen-depleted reformed product gas stream separated from the reforming region 157 may be a carbon dioxide gas stream containing at least 0.8, or at least 0.9, or at least 0.95, or at least 0.98 mole fraction carbon dioxide on a dry basis. The carbon dioxide gas stream is a high pressure gas stream, having a pressure of at least 0.5 MPa, or at least 1 MPa, or at least 2 MPa, or at least 2.5 MPa. Hereafter, the hydrogen-depleted reformed product gas stream will be referred to as the carbon dioxide gas stream.

The high pressure carbon dioxide gas stream may exit the reforming reactor 103 and be utilized to heat the feed precursor in heat exchanger 115 and/or be utilized to heat an oxygen containing gas stream that is fed to the cathode 171 of the fuel cell 105 in heat exchanger 185. The high pressure carbon dioxide gas stream may be utilized to heat the feed precursor by passing the carbon dioxide gas stream through line 187 to heat exchanger 115 while feeding the feed precursor into the heat exchanger 115 through the feed precursor inlet line 113. In an embodiment, the resulting cooled high pressure carbon dioxide stream may then be fed to the heat exchanger 185 through line 189 to heat the oxygen containing gas stream being fed to the cathode 171 of the fuel cell 105. In another embodiment, the cooled high pressure carbon dioxide stream may be expanded through a turbine 147.

Alternatively, the high pressure carbon dioxide gas stream exiting the pre-reforming reactor may be used to heat the oxygen containing gas stream being fed to the cathode 171 of the fuel cell 105 without heating the feed precursor. The high pressure carbon dioxide gas stream may be fed from the reforming reactor 103 through line 183 to the heat exchanger 185 to heat the oxygen containing gas stream and cool the carbon dioxide gas stream. The cooled carbon dioxide gas stream may then be expanded through turbine 147.

Flow of the high pressure carbon dioxide stream from the reforming reactor 103 to the heat exchangers 115 and 185 may be controlled by adjusting metering valves 193 and 195. The metering valves 193 and 195 may be adjusted to control the flow of the carbon dioxide stream to the heat exchangers 115 and 185 to heat the feed precursor and/or the oxygen containing gas streams to a selected temperature. The feed precursor may be heated to a temperature, in conjunction with one or more additional heat exchangers 117 such that the feed precursor has a temperature of at least 150° C., or from 200° C. to 500° C. as the feed precursor is fed to the pre-reforming reactor. The oxygen containing gas may be heated to a temperature such that the cathode exhaust stream exiting the fuel cell has a temperature of from 750° C. to 1100° C., where the oxygen containing gas may be heated to a temperature of from 150° C. to 450° C. The metering valves 193 and 195 may be adjusted automatically by a feedback mechanism, where the feedback mechanism may measure the temperature of the cathode exhaust stream exiting the fuel cell 105 and/or the temperature of the feed precursor entering the pre-reforming reactor 101 and adjust the metering valves 193 and 195 to maintain the temperature of the cathode exhaust stream and/or the feed precursor entering the pre-reforming reactor 101 within set limits while maintaining the internal pressure within the reforming reactor 103 at a desired level.

The high pressure carbon dioxide gas stream may contain significant amounts of water as steam as it exits the reforming reactor 103. In an embodiment, the steam may be removed from the high pressure carbon dioxide gas stream by cooling the high pressure carbon dioxide gas stream in heat exchanger 115 and/or in heat exchanger 185 and, if necessary, one or more additional heat exchangers (not shown) and condensing water from the stream. This may be useful if a relatively pure carbon dioxide stream is desired, for example, for use in enhancing oil recovery from an oil formation, or for use in carbonating beverages.

After passing through heat exchanger 115 and/or heat exchanger 185, the high pressure carbon dioxide stream may be expanded through turbine 147 to drive the turbine 147 and produce a low pressure carbon dioxide stream. Optionally, high pressure steam that is not utilized in the pre-reforming reactor 101 or the reforming reactor 103 may be passed through line 191 to be expanded through the turbine 147 together with the high pressure carbon dioxide stream, or, optionally, without the high pressure carbon dioxide stream. The turbine 147 may be used to generate electricity in addition to electricity generated by the fuel cell 105. Alternatively, the turbine 147 may be used to drive one or more compressors, such as compressors 155 and 197.

A gas stream containing hydrogen, hereinafter the hydrogen gas stream, may be separated from the reformed product gas in the reforming reactor 103 by selectively passing hydrogen through the membrane wall 167 of the hydrogen separation membrane(s) 107 into the hydrogen conduit 169 of the hydrogen separation membrane(s) 107. The hydrogen gas stream may contain a very high concentration of hydrogen, and may contain at least 0.9, or at least 0.95, or at least 0.98 mole fraction hydrogen.

The hydrogen gas stream may be separated from the reformed product gas at a relatively high rate due to the high flux of hydrogen through the hydrogen separation membrane 107. Hydrogen is passed at a high flux rate through the hydrogen separation membrane 107 since hydrogen is present in the reforming reactor 103 at a high partial pressure. The high partial pressure of hydrogen in the reforming reactor 103 is due to 1) significant quantities of hydrogen in the anode exhaust stream fed to the pre-reforming reactor 101 and passed to the reforming reactor 103 in the feed; 2) hydrogen produced in the pre-reforming reactor 101 and fed to the reforming reactor 103; and 3) hydrogen produced in the reforming reactor 103 by the reforming and shift reactions. No sweep gas is necessary to assist removing hydrogen from the hydrogen conduit 169 of the hydrogen separation membrane 107 and out of the reforming reactor 103 due to the high rate that hydrogen is separated from the reformed product.

The hydrogen gas stream may be separated from the reforming reactor 103 through exhaust line 199. The hydrogen gas stream may then be fed to the anode 121 of the solid oxide fuel cell 105 through line 201 into the anode inlet 203. The hydrogen gas stream provides hydrogen to the anode 121 for electrochemical reaction with an oxidant at one or more anode electrodes along the anode path length in the fuel cell 105.

Prior to feeding the hydrogen gas stream to the anode 121 the hydrogen gas stream, or a portion thereof, may be fed to heat exchanger 115 to heat the feed precursor and cool the hydrogen gas stream. The hydrogen gas stream may have a temperature of from 400° C. to 650° C., typically a temperature of from 450° C. to 550° C., upon exiting the reforming reactor 103. The feed precursor may optionally be heated by exchanging heat with the hydrogen gas stream in the heat exchanger 115, and optionally by exchanging heat with the carbon dioxide gas stream as described above. The feed precursor may be heated to a temperature, in conjunction with one or more additional heat exchangers 117, such that the feed precursor has a temperature of at least 150° C., or from 200° C. to 500° C. as the feed precursor is fed to the pre-reforming reactor.

The hydrogen gas stream fed to the anode 121 of the fuel cell 105 may be cooled to a temperature of at most 400° C., or at most 300° C., or at most 200° C., or at most 150° C., or from 20° C. to 400° C., or from 25° C. to 250° C. to control the operating temperature of the solid oxide fuel cell 103 within a range of from 800° C. to 1100° C., in combination with selecting and controlling the temperature of the oxygen containing gas stream fed to the cathode 171 of the fuel cell 105. The hydrogen gas stream, or a portion thereof, may typically be cooled to a temperature of from 200° C. to 400° C. by exchanging heat with the feed precursor in heat exchanger 115. Optionally, the hydrogen gas stream, or a portion thereof, may be cooled further by passing the hydrogen gas stream, or the portion thereof, from the heat exchanger 115 to one or more additional heat exchangers (not shown) to exchange further heat with the feed precursor or with a water stream in each of the one or more additional heat exchangers. If additional heat exchangers are employed in the system 100, the hydrogen gas stream, or the portion thereof, may be cooled to a temperature of from 20° C. to 200° C., preferably from 25° C. to 100° C. In an embodiment, a portion of the hydrogen gas stream may be cooled in heat exchanger 115 and, optionally one or more additional heat exchangers, and a portion of the hydrogen gas stream may be fed to the anode 121 of the fuel cell 105 without being cooled in a heat exchanger, where the combined portions of the hydrogen gas stream may be fed to the anode 121 of the fuel cell 105 at a temperature of at most 400° C., or at most 300° C., or at most 200° C., or at most 150° C., or from 20° C. to 400° C., or from 25° C. to 100° C.

The flow rate of the hydrogen gas stream, or portion thereof, to the heat exchanger 115 and, optionally to one or more additional heat exchangers, may be selected and controlled to control the temperature of the hydrogen gas stream fed to the anode 121 of the fuel cell 105. The flow rate of the hydrogen gas stream, or a portion thereof, to the heat exchanger 115 and the optional additional heat exchanger(s) may be selected and controlled by adjusting metering valves 205 and 207. Metering valve 205 may be adjusted to control the flow of the hydrogen gas stream, or a portion thereof, to the anode 121 of the solid oxide fuel cell 105 through line 209 without cooling the hydrogen gas stream, or the portion thereof. Metering valve 207 may be adjusted to control the flow of the hydrogen gas stream, or a portion thereof, to heat exchanger 115 and any optional additional heat exchangers through line 211. The metering valves 205 and 207 may be adjusted in coordination to provide the desired degree of cooling to the hydrogen gas stream prior to feeding the hydrogen gas stream to the anode 121 of the fuel cell 105. In an embodiment, the metering valves 205 and 207 may be adjusted in coordination automatically in response to feedback measurements of the temperature of the anode exhaust stream and/or the cathode exhaust stream exiting the fuel cell 105.

Any portion of the hydrogen gas stream fed to heat exchanger 115, and optionally the additional heat exchanger(s), may be fed from the heat exchanger 115, or through the last additional heat exchanger used to cool the first gas stream, through line 213 to be combined in line 215 with any portion of the hydrogen gas stream routed around the heat exchanger 115 through line 209. In an embodiment, the combined portions of the hydrogen gas stream may be compressed in compressor 197 to increase the pressure of the hydrogen gas stream, and then the hydrogen gas stream may be fed to the anode 121 of the fuel cell 105 through line 201 to the anode inlet 203. In an embodiment, the hydrogen gas stream may be compressed to a pressure of from 0.15 MPa to 0.5 MPa, or from 0.2 MPa to 0.3 MPa. All or part of the energy required to drive the compressor 197 may be provided by expansion of the high pressure carbon dioxide stream and/or the high pressure steam through turbine 147.

In an embodiment, a sweep gas comprising steam may be injected into the hydrogen conduit 169 of the hydrogen separation device 107 via line 217 to sweep the hydrogen gas stream from the inner portion of the membrane wall member 167, thereby increasing the hydrogen flux through the hydrogen separation device 107 and increasing the rate hydrogen may be separated from the reforming region 157 by the hydrogen separation device 107. The hydrogen gas stream and steam sweep gas may be removed from the hydrogen separation device 107 and the reforming reactor 103 through hydrogen exhaust line 199.

In this embodiment, the hydrogen gas stream and steam sweep gas must be cooled to condense water from the combined hydrogen gas stream and steam sweep gas prior to feeding the hydrogen gas stream to the anode 107. Valve 205 may be closed to prevent the combined hydrogen gas stream and steam sweep gas from being fed to the anode through line 209, or, alternatively, the system 100 may not include line 209 and valve 205 if a steam sweep gas is utilized. The hydrogen gas stream and steam sweep gas are fed to heat exchanger 115 to cool the combined hydrogen gas stream and steam sweep gas by exchange of heat with the feed precursor, as described above. The hydrogen gas stream and steam sweep gas must be cooled sufficiently to separate water from the hydrogen gas stream, therefore, the combined hydrogen gas stream and steam sweep gas may be fed to one or more additional heat exchangers (not shown) to cool the combined hydrogen gas stream and steam sweep gas to condense water from the combined gas streams. The final heat exchanger to cool the combined hydrogen gas stream and steam sweep gas may be a condenser (not shown) in which the steam sweep gas is condensed and separated from the hydrogen gas stream. The hydrogen gas stream may be cooled in the heat exchanger(s) to less than 100° C., or less than 90° C., or less than 70° C., or less than 60° C. to condense and separate the steam sweep gas from the hydrogen gas stream. The separated dry hydrogen gas stream may then be fed to the anode 121 of the fuel cell 105 through lines 213, 215, and 201 and compressor 147 as described above.

The hydrogen gas stream, whether separated from the reforming reactor 103 with a steam sweep gas or not, may then be fed to the anode 121 of the solid oxide fuel cell 105 through line 201 into the anode inlet 203. The hydrogen gas stream provides hydrogen to the anode 121 for electrochemical reaction with an oxidant at one or more anode electrodes along the anode path length in the fuel cell 105. The rate the hydrogen gas stream is fed to the anode 121 of the fuel cell 105 may be selected by selecting the rate that the feed is fed to the reforming reactor 103, which in turn may be selected by the rate that the feed precursor is fed to the pre-reforming reactor 101, which may be controlled by adjusting the feed precursor inlet valve 137.

Alternatively, the rate that the hydrogen gas stream is fed to the anode 121 of the fuel cell 105 may be selected by controlling metering valves 149 and 151 in a coordinated manner. Metering valve 151 may be adjusted to increase or decrease the flow of the hydrogen gas stream into the anode 121. Metering valve 149 may be adjusted to increase or decrease flow of the hydrogen gas stream to a hydrogen storage tank 223. Metering valves 149 and 151 may be controlled in a coordinated manner so that a selected rate of the hydrogen gas stream may be fed to the anode 121 of the fuel cell 105 through line 201 while a portion of the hydrogen gas stream in excess of the amount of hydrogen gas stream required to provide the selected rate may be fed to the hydrogen tank 223 through line 225.

An oxygen containing gas stream is fed to the cathode 171 of the fuel cell through cathode inlet 227 via line 229 to provide the oxidant that may cross the electrolyte and electrochemically react with hydrogen in the hydrogen gas stream at one or more anode electrodes in the fuel cell 105. The oxygen containing gas stream may be provided by an air compressor or an oxygen tank (not shown). In an embodiment, the oxygen containing gas stream may be air or pure oxygen. In another embodiment, the oxygen containing gas stream may be an oxygen enriched air stream containing at least 21% oxygen, where the oxygen enriched air stream provides higher electrical efficiency in the solid oxide fuel cell than air since the oxygen enriched air stream contains more oxygen for conversion into ionic oxygen in the fuel cell.

The oxygen containing gas stream may be heated prior to being fed to the cathode 171 of the fuel cell 105. In one embodiment, the oxygen containing gas stream may be heated to a temperature of from 150° C. to 350° C. prior to being fed to the cathode 171 of the fuel cell 105 in heat exchanger 185 by exchanging heat with at least a portion of the carbon dioxide stream from the reforming reactor 103. In another embodiment, the oxygen containing gas stream may be heated by exchanging heat in heat exchanger 185 with a cooled carbon dioxide stream from heat exchanger 115. In another embodiment, the oxygen containing gas stream may be heated by exchanging heat in heat exchanger 185 with the high pressure steam fed to the heat exchanger 185 through line 231. In another embodiment, the oxygen containing gas stream may be heated in heat exchanger 185 by exchanging heat with a cooled cathode exhaust stream provided to the heat exchanger 185 through line 233 from heat exchanger 117. Alternatively, the oxygen containing gas stream may be heated by an electrical heater (not shown), or the oxygen containing gas stream may be provided to the cathode 171 of the fuel cell 105 without heating.

The solid oxide fuel cell 105 used in the process of the invention may be a conventional solid oxide fuel cell, preferably having a planar or tubular configuration, and is comprised of an anode 121, a cathode 171, and an electrolyte 235 where the electrolyte 235 is interposed between the anode 121 and the cathode 171. The solid oxide fuel cell may be comprised of a plurality of individual fuel cells stacked together-joined electrically by interconnects and operatively connected so that the hydrogen gas stream may flow through the anodes of the stacked fuel cells and the oxygen containing gas may flow through the cathodes of the stacked fuel cells. The solid oxide fuel cell 105 may be either a single solid oxide fuel cell or a plurality of operatively connected or stacked solid oxide fuel cells. In an embodiment, the anode 121 is formed of a Ni/ZrO₂ cermet, the cathode 171 is formed of a doped lanthanum manganite or stabilized ZrO₂ impregnated with praseodymium oxide and covered with SnO doped In₂O₃, and the electrolyte 235 is formed of yttria stabilized ZrO₂ (approximately 8 mol % Y₂O₃). The interconnect between stacked individual fuel cells or tubular fuel cells may be a doped lanthanum chromite.

The solid oxide fuel cell 105 is configured so that the hydrogen gas stream may flow through the anode 121 of the fuel cell 105 from the anode inlet 203 to the anode exhaust outlet 123, contacting one or more anode electrodes over the anode path length from the anode inlet 203 to the anode exhaust outlet 123. The fuel cell 105 is also configured so that the oxygen containing gas may flow through the cathode 171 from the cathode inlet 227 to the cathode exhaust outlet 173, contacting one or more cathode electrodes over the cathode path length from the cathode inlet 227 to the cathode exhaust outlet 173. The electrolyte 235 is positioned in the fuel cell 105 to prevent the hydrogen gas stream from entering the cathode 171 and to prevent the oxygen containing gas from entering the anode 121, and to conduct ionic oxygen from the cathode 171 to the anode 121 for electrochemical reaction with hydrogen in the hydrogen gas stream at the one or more anode electrodes.

The solid oxide fuel cell 105 is operated at a temperature effective to enable ionic oxygen to traverse the electrolyte 235 from the cathode 171 to the anode 121 of the fuel cell 105. The solid oxide fuel cell 105 may be operated at a temperature of from 700° C. to 1100° C., or from 800° C. to 1000° C. The oxidation of hydrogen with ionic oxygen at the one or more anode electrodes is a very exothermic reaction, and the heat of reaction generates the heat required to operate the solid oxide fuel cell 105. The temperature at which the solid oxide fuel cell 105 is operated may be controlled by independently controlling the temperature of the hydrogen gas stream and the oxygen containing gas stream, and the flow rates of these streams to the fuel cell 105. In an embodiment, the temperature of the hydrogen gas stream fed to the fuel cell 105 is controlled to a temperature of at most 400° C., or at most 300° C., or at most 200° C., or at most 100° C., or from 20° C. to 400° C., or from 25° C. to 250° C., and the temperature of the oxygen containing gas stream is controlled to a temperature of at most 400° C., or at most 300° C., or at most 200° C., or at most 100° C., or from 150° C. to 350° C. to maintain the operating temperature of the solid oxide fuel cell 105 in a range from 700° C. to 1000° C., and preferably in a range of from 800° C. to 950° C.

In one embodiment supplemental cooling may be provided to the fuel cell 105 by passing the high pressure steam from line 191 to one or more conduits 261 located about the exterior of the fuel cell 105 or through one or more conduits 263 extending through the interior of the fuel cell 105 to cool the fuel cell 105. The resulting superheated steam may be passed through line 191 and expanded through turbine 147.

To initiate operation of the fuel cell 105, the fuel cell 105 is heated to its operating temperature. In a preferred embodiment, operation of the solid oxide fuel cell 105 may be initiated by generating a hydrogen containing gas stream in a catalytic partial oxidation reforming reactor 237 and feeding the hydrogen containing gas stream through line 239 to the anode 121 of the solid oxide fuel cell. A hydrogen containing gas stream may be generated in the catalytic partial oxidation reforming reactor 237 by combusting a hydrocarbon feed and an oxygen source in the catalytic partial oxidation reforming reactor 237 in the presence of a conventional partial oxidation reforming catalyst, where the oxygen source is fed to the catalytic partial oxidation reforming reactor 237 in a substoichiometric amount relative to the hydrocarbon feed. The hydrocarbon feed may be fed to the catalytic partial oxidation reforming reactor 237 through inlet line 241, and the oxygen source may be fed to the catalytic partial oxidation reforming reactor 237 through line 243.

The hydrocarbon feed fed to the catalytic partial oxidation reforming reactor 237 may be a liquid or gaseous hydrocarbon or mixtures of hydrocarbons, and may be methane, natural gas, or other low molecular weight hydrocarbon or mixture of low molecular weight hydrocarbons. In a particularly preferred embodiment of the process of the invention, the hydrocarbon feed fed to the catalytic partial oxidation reforming reactor 237 may a feed of the same type as the feed precursor used in the pre-reforming reactor 101 to reduce the number of hydrocarbon feeds required run the process, and may be fed from the feed inlet line 113 to the catalytic partial oxidation reforming reactor 237 via line 245.

The oxygen containing feed fed to the catalytic partial oxidation reforming reactor 237 may be pure oxygen, air, or oxygen enriched air. The oxygen containing feed should be fed to the catalytic partial oxidation reforming reactor 237 in substoichiometric amounts relative to the hydrocarbon feed to combust with the hydrocarbon feed in the catalytic partial oxidation reforming reactor 237. In an embodiment the oxygen containing feed fed to the catalytic partial oxidation reforming reactor 237 is from the same source as the oxygen containing gas stream used in operating the fuel cell 105 after start-up, and may be fed from the oxygen containing gas stream inlet line 221 to the catalytic partial oxidation reforming reactor 237 through line 243

The hydrogen containing gas stream formed by combustion of the hydrocarbon feed and the oxygen containing gas in the catalytic partial oxidation reforming reactor 237 contains compounds that may be oxidized in the anode 121 of the fuel cell 105 by contact with an oxidant at one or more of the anode electrodes, including hydrogen and carbon monoxide, as well as other compounds such as carbon dioxide. The hydrogen containing gas steam from the catalytic partial oxidation reforming reactor 237 should not contain compounds that may oxidize the one or more anode electrodes in the anode 121 of the fuel cell 105.

The hydrogen containing gas stream formed in the catalytic partial oxidation reforming reactor 237 is hot, and may have a temperature of at least 700° C., or from 700° C. to 1100° C., or from 800° C. to 1000° C. Use of the hot hydrogen gas stream from a catalytic partial oxidation reforming reactor 237 to initiate start up of the solid oxide fuel cell 105 is preferred in the process of the invention since it enables the temperature of the fuel cell 105 to be raised to the operating temperature of the fuel cell 105 almost instantaneously. In an embodiment, heat may be exchanged in heat exchanger 185 between the hot hydrogen containing gas from the catalytic partial oxidation reforming reactor 237 and an oxygen containing gas fed to the cathode 171 of the fuel cell 105 when initiating operation of the fuel cell 105 to heat the oxygen containing gas.

Upon reaching the operating temperature of the fuel cell 105, the flow of the hot hydrogen containing gas stream from the catalytic partial oxidation reforming reactor 237 into the fuel cell 105 may be shut off by valve 249, while feeding the hydrogen gas stream from the reforming reactor 103 into the anode 121 by opening valve 151 and feeding the oxygen containing gas stream into the cathode 171 of the fuel cell 105. If the hydrocarbon feed to the catalytic partial oxidation reforming reactor is from the same source as the feed precursor, valve 251 may be closed to prevent flow of the hydrocarbon feed to the catalytic partial oxidation reforming reactor 237 during operation of the fuel cell 105. Likewise, if the oxygen containing feed to the catalytic partial oxidation reforming reactor 237 is from the same source as the oxygen containing gas stream used in the cathode 171 of the fuel cell 105, valve 253 may be closed to prevent flow of the oxygen containing feed to the catalytic partial oxidation reforming reactor 237 during operation of the fuel cell 105. Continuous operation of the fuel cell may then conducted according to the process of the invention.

In another embodiment, operation of the fuel cell 105 may be initiated with a hydrogen start-up gas stream from hydrogen storage tank 223 that may be passed through a start-up heater 255 to bring the fuel cell 105 up to its operating temperature prior to introducing the hydrogen gas stream into the fuel cell 105. The hydrogen storage tank 223 may be operatively connected to the fuel cell 105 to permit introduction of the hydrogen start-up gas stream into the anode 121 of the solid oxide fuel cell 105. The start-up heater 255 may indirectly heat the hydrogen start-up gas stream to a temperature of from 750° C. to 1000° C. The start-up heater 255 may be an electrical heater or may be a combustion heater. Upon reaching the operating temperature of the fuel cell 105, the flow of the hydrogen start-up gas stream into the fuel cell 105 may be shut off by a valve 257, and the hydrogen gas stream and the oxygen containing gas stream may be introduced into the fuel cell 105 to start the operation of the fuel cell.

During initiation of operation of the fuel cell 105, an oxygen containing gas stream may be introduced into the cathode 171 of the fuel cell 105. The oxygen containing gas stream may be air, oxygen enriched air containing at least 21% oxygen, or pure oxygen. Preferably, the oxygen containing gas stream is the oxygen containing gas stream that will be fed to the cathode 171 during operation of the fuel cell 105 during operation of the fuel cell 105 after initiating operation of the fuel cell.

In a preferred embodiment, the oxygen containing gas stream fed to the cathode 171 of the fuel cell 105 during start-up of the fuel cell 105 has a temperature of at least 500° C., more preferably at least 650° C., and more preferably at least 750° C. The oxygen containing gas stream may be indirectly heated by an electric heater (not shown) or a combustion heater (not shown) before being fed to the cathode 171 of the solid oxide fuel cell 105. In a preferred embodiment, the oxygen containing gas stream used in initiating operation of the fuel cell 105 may be heated by heat exchange with a hot hydrogen containing gas stream from a catalytic partial oxidation reforming reaction in heat exchanger 185 prior to being fed to the cathode 171 of the fuel cell 105.

Once operation of the fuel cell 105 has commenced, the hydrogen gas stream may be mixed with an ionic oxygen oxidant at one or more anode electrodes in the fuel cell 105 to generate electricity. The ionic oxygen oxidant is derived from oxygen in the oxygen-containing gas stream flowing through the cathode 171 of the fuel cell 105 and conducted across the electrolyte 235 of the fuel cell. The hydrogen gas stream fed to the anode 121 of the fuel cell 105 and the oxidant are mixed in the anode 121 at the one or more anode electrodes of the fuel cell 105 by feeding the hydrogen gas stream and the oxygen containing gas stream to the fuel cell 105 at selected independent rates while operating the fuel cell at a temperature of from 750° C. to 1100° C.

The hydrogen gas stream and the oxidant are preferably mixed at the one or more anode electrodes of the fuel cell 105 to generate electricity at an electrical power density of at least 0.4 W/cm², more preferably at least 0.5 W/cm², or at least 0.75 W/cm², or at least 1 W/cm², or at least 1.25 W/cm², or at least 1.5 W/cm². Electricity may be generated at such electrical power densities by selecting and controlling the rate that the hydrogen gas stream is fed to the anode 121 of the fuel cell 105 and the rate that the oxygen containing gas stream is fed to the cathode 171 of the fuel cell 105. The flow rate of the oxygen containing gas stream to the cathode 171 of the fuel cell 105 may be selected and controlled by adjusting the oxygen gas inlet valve 259.

As described above, the flow rate of the hydrogen gas stream to the anode 121 of the fuel cell 105 may be selected and controlled by selecting and controlling the rate that the feed is fed to the reforming reactor 103, which in turn may be selected and controlled by the rate that the feed precursor is fed to the pre-reforming reactor 101, which may be selected and controlled by adjusting the feed precursor inlet valve 137. Alternatively, as described above, the rate that the hydrogen gas stream is fed to the anode 121 of the fuel cell 105 may be selected and controlled by controlling metering valves 149 and 151 in a coordinated manner. In an embodiment, the metering valves 149 and 151 may be automatically adjusted by a feedback mechanism to maintain a selected flow rate of the hydrogen gas stream to the anode 121, where the feedback mechanism may operate based upon measurements of hydrogen content in the anode exhaust stream, or water content in the anode exhaust stream, or the ratio of water formed in the fuel cell relative to hydrogen in the anode exhaust stream.

In the process of the invention, mixing the hydrogen gas stream and the oxidant at the one or more anode electrodes generates water (as steam) by the oxidation of a portion of hydrogen present in the hydrogen gas stream fed to the fuel cell 105 with the oxidant. Water generated by the oxidation of hydrogen with an oxidant is swept through the anode 121 of the fuel cell 105 by the unreacted portion of the hydrogen gas stream to exit the anode 121 as part of the anode exhaust stream.

In an embodiment of the process of the invention, the flow rate that the hydrogen gas stream is fed to the anode 121 may be selected and controlled so the ratio of amount of water formed in the fuel cell 105 per unit of time to the amount of hydrogen in the anode exhaust per unit of time is at most 1.0, or at most 0.75, or at most 0.67, or at most 0.43, or at most 0.25, or at most 0.11. In an embodiment, the amount of water formed in the fuel cell 105 and the amount of hydrogen in the anode exhaust may be measured in moles so that the ratio of the amount of water formed in the fuel cell per unit of time to the amount of hydrogen in the anode exhaust per unit of time in moles per unit of time is at most 1.0, or at most 0.75, or at most 0.67, or at most 0.43, or at most 0.25, or at most 0.11. In an embodiment, the flow rate that the hydrogen gas stream is fed to the anode 121 may be selected and controlled so the per pass hydrogen utilization rate in the fuel cell 105 is less than 50%, or at most 45%, or at most 40%, or at most 30%, or at most 20%, or at most 10%.

In another embodiment of the process of the invention, the flow rate that the hydrogen gas stream is fed to the anode 121 may be selected and controlled so the anode exhaust stream contains at least 0.6, or at least 0.7, or at least 0.8, or at least 0.9 mole fraction hydrogen. In an another embodiment, the flow rate that the hydrogen gas stream is fed to the anode 121 may be selected and controlled so the anode exhaust stream contains greater than 50%, or at least 60%, or at least 70%, or at least 80%, or at least 90% of the hydrogen in the hydrogen gas stream fed to the anode 121.

The flow rate of the oxygen containing gas stream provided to the cathode 171 of the solid oxide fuel cell 105 should be selected to provide sufficient oxidant to the anode to generate electricity at an electrical power density of at least 0.4 W/cm², or at least 0.5 W/cm², or at least 0.75 W/cm², or at least 1 W/cm², or at least 1.25 W/cm², or at least 1.5 W/cm² when combined with the fuel from the hydrogen gas stream at the one or more anode electrodes. As noted above, the flow rate of the oxygen containing gas stream to the cathode 171 may be selected and controlled by adjusting the oxygen gas inlet valve 259. In the process of the present invention relatively little carbon dioxide is generated per unit of electricity produced by the process. The thermal integration of the pre-reforming reactor 101 and the reforming reactor 103 with the fuel cell 105—wherein the heat produced in the fuel cell 105 is transferred directly within the pre-reforming reactor 101 in the anode exhaust stream from the fuel cell 105, and subsequently directly within the reforming reactor 103 in the feed from the pre-reforming reactor 101—reduces, and preferably eliminates, additional energy required to be provided to drive the endothermic pre-reforming and reforming reactions, reducing the need to provide such energy, for example by combustion, thereby reducing the amount of carbon dioxide produced in providing energy to drive the reforming reaction. Additionally, recycling the anode exhaust stream through the system 100 and provision of a hydrogen-rich first gas stream to the fuel cell 105 by separating the hydrogen-rich first gas stream from the reformed gas product then feeding the first gas stream to the fuel cell 105 reduces the amount of hydrogen required to be produced by the reforming reactor 301 and increases the electrical efficiency of the process, thereby reducing attendant carbon dioxide by-product production.

In the process of the present invention, carbon dioxide is generated at a rate of no more than 400 grams per kilowatt-hour (400 g per kWh) of electricity generated. In a preferred embodiment, carbon dioxide is generated in the process of the present invention at a rate of no more than 350 g per kWh, and in a more preferred embodiment, carbon dioxide is generated in the process of the present invention at a rate of no more than 300 g per kWh.

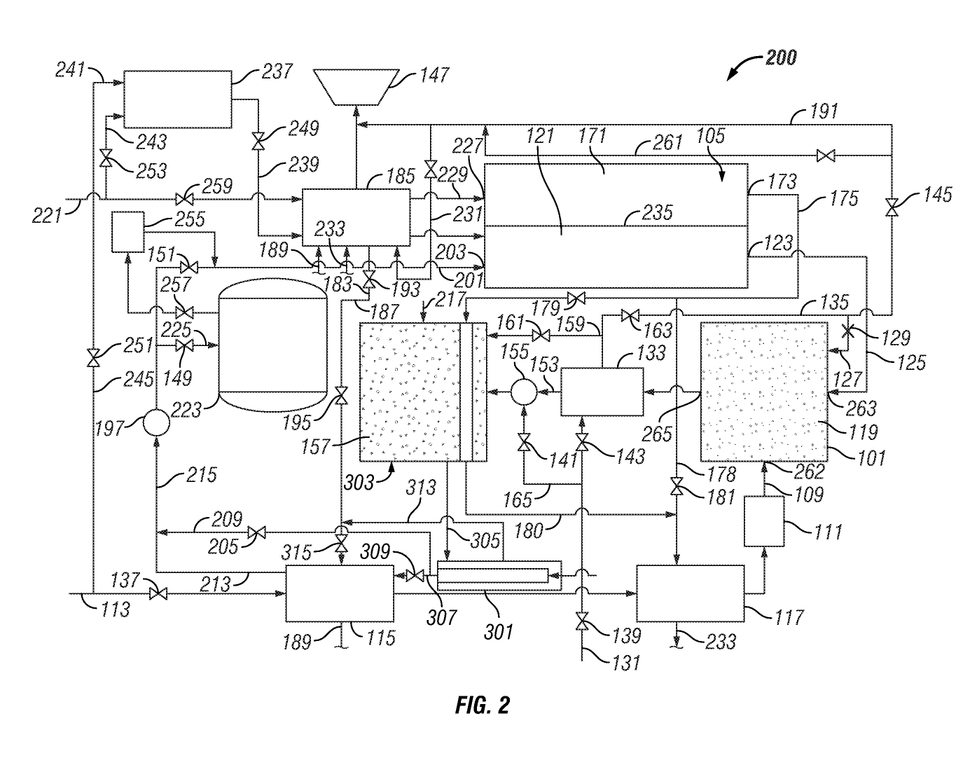

In another embodiment, the process of the present invention utilizes a system including a thermally integrated steam reformer, a hydrogen-separating device located exterior to the steam reformer, and a solid oxide fuel cell. Referring now to FIG. 2, the system 200 for practicing the process of this embodiment is similar to the system 100 shown in FIG. 1, and the system components are generally numbered the same, excepting the reforming reactor 303, the hydrogen-separation device 301 and its components, and certain lines connecting the hydrogen-separation device 301 into the system 200. The hydrogen-separation device 301 is not located in the reforming reactor 303, but is operatively coupled to the reforming reactor 303 so that a reformed product gas containing hydrogen and carbon oxides formed in the reforming reactor 303 and unreacted hydrocarbons and steam are passed through line 305 to the hydrogen-separation device 301. In one embodiment, the hydrogen-separation device 301 is a high temperature hydrogen-separation device, preferably a tubular hydrogen permeable membrane apparatus as described above. In another embodiment, the hydrogen-separation device 301 may be a hydrogen separation device that operates at temperatures of less than 150° C., or less than 100° C., such as a pressure swing adsorption apparatus.

A hydrogen gas stream containing hydrogen may be separated from the reformed product gas and unreacted steam and hydrocarbons by the hydrogen separation device 301. In an embodiment, the hydrogen separation device 301 is a tubular hydrogen permeable, hydrogen selective membrane apparatus in which the hydrogen gas stream may be separated from the reformed product gas, steam, and unreacted hydrocarbons at or near the operating temperature of the reforming reactor 303, after which the hydrogen gas stream may be fed to the anode 121 of the fuel cell 105, either directly or through heat exchanger 115. The hydrogen gas stream may be fed directly to the anode 121 from the hydrogen separation device 301 without cooling through line 209. Alternatively, the hydrogen gas stream may be cooled in heat exchanger 115 prior to being fed to the anode 121 by passing the hydrogen gas stream through line 307 to the heat exchanger 115, where valve 309 may be used to control the flow of the hydrogen gas stream to the heat exchanger 115.

In an embodiment, a steam sweep gas may be injected into the tubular hydrogen permeable, hydrogen selective membrane apparatus 301 through line 311 to facilitate separation of the hydrogen gas stream. In this embodiment, the hydrogen gas stream and steam sweep gas may be fed from the tubular hydrogen permeable, hydrogen selective membrane 301 to the heat exchanger 115, and subsequently to a condenser (not shown) to separate the sweep gas from the hydrogen gas stream, and then the hydrogen gas stream may be fed to the anode 121 of the solid oxide fuel cell 105 as described above.

In another embodiment, the hydrogen separation device 301 may be a pressure swing adsorption apparatus. In this embodiment, the reformed product gas, steam, and unreacted feed may be cooled in one or more heat exchangers (not shown), operatively connected between the reforming reactor 303 and the hydrogen separation device 301 and connected by line 305, to a temperature at which the pressure swing adsorption apparatus may be utilized to separate the hydrogen gas stream from other compounds in the mixture of reformed product gas, steam and unreacted feed—typically a temperature of below 150° C., or below 100° C., or below 75° C.

Gaseous non-hydrogen reformed products and unreacted feed may be separated as a gaseous stream from the hydrogen separation device 301 via line 313. The non-hydrogen reformed products and unreacted feed may include carbon dioxide, water (as steam), and small amounts of carbon monoxide and unreacted hydrocarbons. The non-hydrogen reformed products and unreacted feed may be fed to either heat exchanger 185 or heat exchanger 115 for cooling and to heat the oxygen containing gas fed to the cathode 171 of the fuel cell 105 or the feed precursor, respectively, via line 187. Valves 195 and 315 may be used to control the flow of the non-hydrogen reformed products and unreacted feed to heat exchanger 185 and/or heat exchanger 115.

The remainder of the process utilizing the hydrogen separation device 301 located outside of the reforming reactor 303 may be practiced in generally the same manner as the process described above with respect to the solid oxide fuel cell 105 and the reforming reactor 103 containing the hydrogen separation membrane 107 therein, as described above.

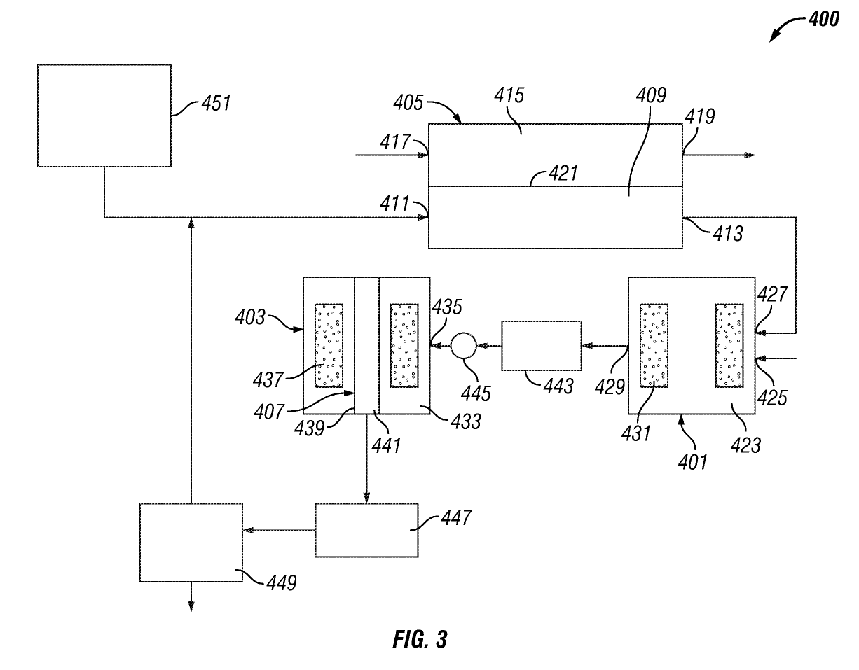

In another aspect, the present invention is directed to a system of generating electricity. Referring now to FIG. 3, the system 400 includes a pre-reforming reactor 401, a reforming reactor 403, a solid oxide fuel cell 405, and a hydrogen separation apparatus 407.

The solid oxide fuel cell 405 of the system 400 includes an anode 409 having an anode inlet 411 and an anode exhaust outlet 413, a cathode 415 having a cathode inlet 417 and a cathode exhaust outlet 419, and an electrolyte 421 positioned between contacting and separating the anode 409 and the cathode 415. Solid oxide fuel cells useful in the system of the present invention, their anodes, cathodes, and electrolytes are described in further detail above.

The pre-reforming reactor 401 includes a pre-reforming region 423, one or more pre-reforming reactor feed precursor inlets 425, one or more pre-reforming reactor anode exhaust inlets 427, and one or more pre-reforming reactor outlets 429. The pre-reforming region 423 of the pre-reforming reactor 401 is adapted to crack one or more hydrocarbons of a feed precursor to form a feed, where a cracked hydrogen in the feed has a reduced molecular weight and a reduced carbon atom content therein than the hydrocarbon from which it is derived in the feed precursor. The pre-reforming region 423 contains a cracking catalyst 431 therein positioned to contact a vaporized mixture of steam and one or more hydrocarbons in the pre-reforming region 423. The cracking catalyst 431 may be a pre-reforming catalyst as described in further detail above. The one or more pre-reforming feed precursor inlets 425 are coupled in gas/fluid communication with the pre-reforming region 423 of the pre-reforming reactor 401 so that a liquid or gaseous feed precursor may be introduced into the pre-reforming region 423 of the pre-reforming reactor 401 through the pre-reforming reactor feed precursor inlet(s) 425. The one or more pre-reforming reactor anode exhaust inlets 427 are coupled in gaseous communication with the pre-reforming region 423 of the pre-reforming reactor 401 and operatively coupled in gaseous communication with the anode exhaust outlet 413 of the fuel cell 405 so that an anode exhaust stream exiting the fuel cell 405 from the anode exhaust outlet 413 may be introduced into the pre-reforming region 423 of the pre-reforming reactor 401 through the one or more pre-reforming reactor anode exhaust inlets 427. In an embodiment, the anode exhaust outlet 413 is directly coupled in gaseous communication with the one or more pre-reforming reactor anode exhaust inlets 427. The one or more pre-reforming reactor outlets 429 are in gaseous communication with the pre-reforming region 423 of the pre-reforming reactor 401.

The reforming reactor 403 of the system 400 includes a reforming region 433 and one or more reforming region inlets 435. The reforming region 433 of the reforming reactor 403 is adapted to reform a vaporized mixture of steam and a feed comprising one or more hydrocarbons to form a reformed product gas containing hydrogen. The reforming region 433 contains a reforming catalyst 437 therein positioned to contact a vaporized mixture of steam and a feed comprising one or more hydrocarbons in the reforming region 433. The reforming catalyst may be a reforming catalyst as described in further detail above. The one or more reforming region inlets 435 are coupled in gaseous communication with the reforming region 433 and operatively coupled in gaseous communication with one or more pre-reforming reactor outlets 429 to permit feed and steam from the pre-reforming reactor 401 to be introduced into the reforming region 433 of the reforming reactor 403 through the reforming region inlets 435.

The hydrogen separation apparatus 407 of the system 400 includes a member 439 that is selectively permeable to hydrogen and a hydrogen gas outlet 441. The hydrogen permeable member 439 of the hydrogen separation apparatus 407 may be located in the reforming region 433 of the reforming reactor 403 in gaseous communication with the reforming region 433 of the reforming reactor 403 so the hydrogen permeable member 439 may contact vaporized gases in the reforming region 433 of the reforming reactor 403. The hydrogen gas outlet 441 is coupled in gaseous communication with the hydrogen permeable member 439, where the hydrogen permeable member 439 is interposed between the reforming region 433 of the reforming reactor 403 and the hydrogen gas outlet 441 to permit selective flow of hydrogen from the reforming region 433 to the hydrogen gas outlet 441 through the hydrogen permeable member 439. The hydrogen gas outlet is also operatively coupled in gaseous communication with the anode inlet 411 of the fuel cell 405 to permit the flow of a hydrogen gas stream from the hydrogen separation apparatus 407 to the anode 409 of the fuel cell 405.

In an embodiment, the system 400 may include a first heat exchanger 443. The first heat exchanger may be operatively coupled in gaseous communication with the one or more pre-reforming reactor outlets 429 of the pre-reforming reactor 401 and operatively coupled in gaseous communication with the one or more reforming region inlets 435 of the reforming reactor 403 so the first heat exchanger may cool a feed passing from the pre-reforming reactor 401 to the reforming reactor 403.

In an embodiment, the system 400 may include a compressor 445. The compressor 445 may be operatively coupled in gaseous communication with the one or more pre-reforming reactor outlets 429 of the pre-reforming reactor 401 and operatively coupled in gaseous communication with the one or more reforming region inlets 435 of the reforming reactor 403 so the compressor 445 may compress a feed passing from the pre-reforming reactor 401 to the reforming reactor 403. In an embodiment, the compressor 445 may be coupled in gaseous communication with the first heat exchanger 443 and the reforming region inlets 435 of the reforming reactor 403 so the compressor 445 may compress a feed cooled by the first heat exchanger 443 as the feed passes from the pre-reforming reactor 401 to the reforming reactor 403.

In an embodiment, the system 400 may include a second heat exchanger 447. The second heat exchanger 447 may be operatively connected to the hydrogen gas outlet 441 of the hydrogen separation apparatus 407 and may be operatively connected to the anode inlet 411 of the anode 409 of the fuel cell 405 so the second heat exchanger 447 may cool a hydrogen gas stream passing from the hydrogen separation apparatus 447 to the anode 409 of the fuel cell 405.

In embodiment, the system 400 may include a condenser 449. The condenser 449 may be operatively connected to the hydrogen gas outlet 441 of the hydrogen separation apparatus 407 and may be operatively connected to the anode inlet 411 of the anode 409 of the fuel cell 405 so the condenser 449 may condense water from a hydrogen gas stream passing from the hydrogen separation apparatus 407 to the anode 409 of the fuel cell 405 when a steam sweep gas is utilized to sweep hydrogen out of the hydrogen separation apparatus 407. In an embodiment, the second heat exchanger 447 may be operatively connected to the hydrogen gas outlet 441 of the hydrogen separation apparatus 407 and may be operatively connected to the condenser 449, where the condenser 449 is operatively connected to the anode inlet 411 of the anode 409 of the fuel cell 405 so that a hydrogen gas stream passing from the hydrogen separation apparatus 407 to the anode 409 of the fuel cell 405 may be first cooled in the second heat exchanger 447 and then have water condensed from the hydrogen gas stream in the condenser 449.

In an embodiment, the system 400 may include a catalyst partial oxidation reactor 451. The catalytic partial oxidation reactor may be operatively connected to the anode inlet 411 of the anode 409 of the fuel cell 405, where the catalytic partial oxidation reactor is effective to provide a start-up hydrogen gas stream to the anode 409 of the fuel cell 405 to initiate operation of the fuel cell 405.

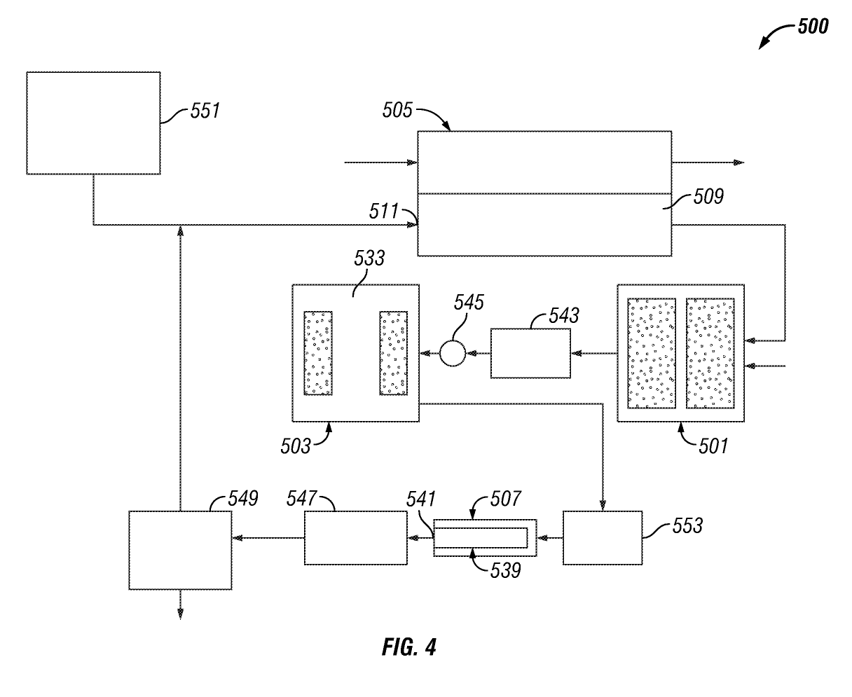

In another embodiment, as shown in FIG. 4, the system 500 may comprise a pre-reforming reactor 501, a reforming reactor 503, a solid oxide fuel cell 505, and a hydrogen separation apparatus 507 as described above with respect to system 400, except the hydrogen separation apparatus 507 is located outside the reforming reactor 503 and is operatively connected in gaseous communication with the reforming region 533 of the reforming reactor 503. The hydrogen-permeable, hydrogen-selective member 539 is operatively coupled in gaseous communication with the reforming region 533 of the reforming reactor 503 so the reformed gas products produced in the reforming region 533 may pass from the reforming region 533 to the member 539 so hydrogen may be separated from the reformed product gas by the member 539.

In one embodiment, the member 539 may be a high-temperature hydrogen-permeable, hydrogen-selective membrane, as described above. In another embodiment, the member 539 may be a pressure swing adsorber. In an embodiment, particularly if the member 539 is a pressure swing adsorber, one or more heat exchangers 553 may be coupled in gaseous communication between the reforming region 533 of the reforming reactor 503 and the member 539 to cool the reformed product gas prior to separating hydrogen from the reformed product gas with the member 539.

The hydrogen gas outlet 541 of the hydrogen separation apparatus 507 is located in gaseous communication with the selectively hydrogen permeable member 539 of the hydrogen separation apparatus 507. The selectively hydrogen permeable member 539 is interposed between the reforming region 533 of the reforming reactor 503 and the hydrogen gas outlet 541 to permit selective flow of hydrogen from the reforming region 533 through the hydrogen permeable member 539 and out of the hydrogen separation apparatus 507 through hydrogen gas outlet 541.

The hydrogen gas outlet 541 is operatively coupled in gaseous communication with the anode inlet 511 of the fuel cell 505 so that hydrogen produced in the reforming reactor 503 and separated from a reformed product gas by the hydrogen separation apparatus 507 may be fed to the anode 509 of the fuel cell 505. As described above with respect to the system 400 where the hydrogen separation apparatus 407 is located in the reforming reactor 403, one or more heat exchangers 547 and a condenser 549 may be operatively coupled in gaseous communication between the hydrogen gas outlet 541 and the anode inlet 511 to cool the hydrogen gas stream exiting the hydrogen gas outlet 541 and condense water from the hydrogen gas stream prior to the hydrogen gas stream entering the anode 509 of the fuel cell 505.

Further as described above with respect to the system 400 shown in FIG. 3, system 500 shown in FIG. 4 may include a heat exchanger 543 and compressor 545 operatively connected between the pre-reforming reactor 501 and reforming reactor 403, and may include a catalytic partial oxidation reactor 551 for initiating operation of the fuel cell 505 operatively connected to the anode inlet 511 of the fuel cell 505.

In an embodiment, the system of the present invention may be a system as depicted in FIG. 1 and described above in the description of a process of the present invention.

In an embodiment, the system of the present invention may be a system as depicted in FIG. 2 and described above in the description of a process of the present invention.

That which is claimed is:

1. A system for generating electricity, comprising:
a) a solid oxide fuel cell comprising
1) an anode having
(i) an anode inlet; and
(ii) an anode exhaust outlet;
2) a cathode having
(i) a cathode inlet; and
(ii) a cathode exhaust outlet; and
3) an electrolyte positioned between contacting and separating the anode and the cathode;
b) a pre-reforming reactor comprising
1) a pre-reforming region adapted to crack one or more hydrocarbons in a feed precursor to form a feed, said pre-reforming region containing a cracking catalyst therein positioned to contact a vaporized mixture of steam and one or more hydrocarbons of a feed precursor;
2) one or more pre-reforming reactor feed precursor inlets coupled in gas/fluid communication with the pre-reforming region through which a feed precursor may be introduced into the pre-reforming region; and
3) one or more pre-reforming reactor anode exhaust inlets coupled in gaseous communication with the pre-reforming region and operatively coupled in gaseous communication with the anode exhaust outlet, through which an anode exhaust stream from the fuel cell may be introduced into the pre-reforming region; and
4) one or more pre-reforming reactor outlets in gaseous communication with the pre-reforming region;
c) a reforming reactor comprising
1) a reforming region adapted to reform a vaporized mixture of steam and a feed comprising one or more gaseous hydrocarbons, said reforming region containing a reforming catalyst therein positioned to contact the vaporized mixture of steam and feed in the reforming region; and
2) one or more reforming region inlets coupled in gaseous communication with the reforming region and operatively coupled in gaseous communication with one or more pre-reforming reactor outlets to permit feed and steam from the pre-reforming reactor to be introduced into the reforming region of the reforming reactor; and
d) a hydrogen separation apparatus having
1) a member selectively permeable to hydrogen located in the reforming region of the reforming reactor and in gaseous communication with the reforming region of the reforming reactor;
2) a hydrogen gas outlet located in gaseous communication with the member, the member being interposed between the reforming region of the reforming reactor and the hydrogen gas outlet to permit selective flow of hydrogen from the reforming region to the hydrogen gas outlet through the member, wherein the hydrogen gas outlet is operatively coupled in gaseous communication with the anode inlet of the fuel cell to permit the flow of a hydrogen gas stream from the hydrogen separation apparatus to the anode of the fuel cell.

2. The system of claim 1 wherein the anode exhaust outlet is directly coupled in gaseous communication with the one or more pre-reforming reactor anode exhaust inlets.

3. The system of claim 1 further comprising a first heat exchanger operatively coupled in gaseous communication with the one or more pre-reforming reactor outlets and operatively coupled in gaseous communication with the one or more reforming region inlets of the reforming reactor so the first heat exchanger may cool a feed passing from the pre-reforming reactor to the reforming reactor.

4. The system of claim 3 further comprising a compressor coupled in gaseous communication with the first heat exchanger and the reforming region inlets of the reforming reactor so the compressor may compress a feed passing from the first heat exchanger to the reforming reactor.

5. The system of claim 1 further comprising a compressor operatively coupled in gaseous communication with the one or more pre-reforming reactor outlets and the one or more reforming region inlets of the reforming reactor so the compressor may compress a feed passing from the pre-reforming reactor to the reforming reactor.

6. The system of claim 1 further comprising a condenser operatively connected in gaseous communication with the hydrogen gas outlet of the hydrogen separation apparatus and the anode inlet of the anode of the fuel cell, said condenser being effective to condense water from a hydrogen gas stream passing from the hydrogen separation apparatus to the anode of the fuel cell.

7. The system of claim 6 further comprising a second heat exchanger operatively connected with the hydrogen gas outlet of the hydrogen separation apparatus and the condenser, said second heat exchanger being effective to cool a hydrogen gas stream passing from the hydrogen separation apparatus to the condenser.

8. The system of claim 1 further comprising a second heat exchanger operatively connected to the hydrogen gas outlet of the hydrogen separation apparatus and the anode inlet of the anode of the fuel cell, said second heat exchanger being effective to cool a hydrogen gas stream passing from the hydrogen separation apparatus to the anode of the fuel cell.

9. The system of claim 1 further comprising a catalytic partial oxidation reactor operatively connected to the anode inlet of the anode of the fuel cell, said catalyst partial oxidation reactor being effective to provide a start-up hydrogen gas stream to initiate operation of the fuel cell.

10. A system for generating electricity, comprising:
a) a solid oxide fuel cell comprising
1) an anode having
(i) an anode inlet; and
(ii) an anode exhaust outlet;
2) a cathode having
(i) a cathode inlet; and
(ii) a cathode exhaust outlet; and
3) an electrolyte positioned between contacting and separating the anode and the cathode;
b) a pre-reforming reactor comprising
1) a pre-reforming region adapted to crack one or more hydrocarbons in a feed precursor to form a feed, said pre-reforming region containing a cracking catalyst therein positioned to contact a vaporized mixture of steam and one or more hydrocarbons of a feed precursor;
2) one or more pre-reforming reactor feed precursor inlets coupled in gas/fluid communication with the pre-reforming region through which a feed precursor may be introduced into the pre-reforming region; and
3) one or more pre-reforming reactor anode exhaust inlets coupled in gaseous communication with the pre-reforming region and operatively coupled in gaseous communication with the anode exhaust outlet, through which an anode exhaust stream from the fuel cell may be introduced into the pre-reforming region; and
4) one or more pre-reforming reactor outlets in gaseous communication with the pre-reforming region;
c) a reforming reactor comprising
1) a reforming region adapted to reform a vaporized mixture of steam and a feed comprising one or more gaseous hydrocarbons, said reforming region containing a reforming catalyst therein positioned to contact the vaporized mixture of steam and feed in the reforming region; and
2) one or more reforming region inlets coupled in gaseous communication with the reforming region and operatively coupled in gaseous communication with one or more pre-reforming reactor outlets to permit feed and steam from the pre-reforming reactor to be introduced into the reforming region of the reforming reactor; and
d) a hydrogen separation apparatus having
1) a member selectively permeable to hydrogen operatively connected in gaseous communication with the reforming region of the reforming reactor;
2) a hydrogen gas outlet located in gaseous communication with the member, the member being interposed between the reforming region of the reforming reactor and the hydrogen gas outlet to permit selective flow of hydrogen from the reforming region to the hydrogen gas outlet through the member, wherein the hydrogen gas outlet is operatively coupled in gaseous communication with the anode inlet of the fuel cell to permit the flow of a hydrogen gas stream from the hydrogen separation apparatus to the anode of the fuel cell.

11. The system of claim 10 wherein the anode exhaust outlet is directly coupled in gaseous communication with the one or more pre-reforming reactor anode exhaust inlets.

12. The system of claim 10 further comprising a first heat exchanger operatively coupled in gaseous communication with the one or more pre-reforming reactor outlets and operatively coupled in gaseous communication with the one or more reforming region inlets of the reforming reactor so the first heat exchanger may cool a feed passing from the pre-reforming reactor to the reforming reactor.

13. The system of claim 12 further comprising a compressor coupled in gaseous communication with the first heat exchanger and the reforming region inlets of the reforming reactor so the compressor may compress a feed passing from the first heat exchanger to the reforming reactor.

14. The system of claim 10 further comprising a compressor operatively coupled in gaseous communication with the one or more pre-reforming reactor outlets and the one or more reforming region inlets of the reforming reactor so the compressor may compress a feed passing from the pre-reforming reactor to the reforming reactor.

15. The system of claim 10 further comprising a condenser operatively connected in gaseous communication with the hydrogen gas outlet of the hydrogen separation apparatus and the anode inlet of the anode of the fuel cell, said condenser being effective to condense water from a hydrogen gas stream passing from the hydrogen separation apparatus to the anode of the fuel cell.

16. The system of claim 15 further comprising a second heat exchanger operatively connected with the hydrogen gas outlet of the hydrogen separation apparatus and the condenser, said second heat exchanger being effective to cool a hydrogen gas stream passing from the hydrogen separation apparatus to the condenser.

17. The system of claim 10 further comprising a second heat exchanger operatively connected to the hydrogen gas outlet of the hydrogen separation apparatus and the anode inlet of the anode of the fuel cell, said second heat exchanger being effective to cool a hydrogen gas stream passing from the hydrogen separation apparatus to the anode of the fuel cell.

18. The system of claim 10 further comprising a catalytic partial oxidation reactor operatively connected to the anode inlet of the anode of the fuel cell, said catalyst partial oxidation reactor being effective to provide a start-up hydrogen gas stream to initiate operation of the fuel cell.
